(19) United States
(12) Patent Application Publication
(10) Pub. No.: US 2026/0203773 A1
(43) Pub. Date: Jul. 16, 2026

(54) Systems And Methods To Verify A Candidate Assertion In An Electronic Content Item

(71) Applicant: Mindcorp, Inc., NEW YORK, NY (US)

(72) Inventors: Nova Spivack, Jupiter, FL (US); Michelle Crames, Los Angeles, CA (US); James Beeby, Denver, CO (US); Harris Greenstein, Morristown, NJ (US); Samuel Douglas, Stafford, VA (US)

(21) Appl. No.: 19/440,919

(22) Filed: Jan. 6, 2026

Related U.S. Application Data
(60) Provisional application No. 63/743,690, filed on Jan. 10, 2025.

(51) Int. Cl. G06Q 30/018; G06F 18/24

(52) U.S. Cl. CPC G06Q 30/018; G06F 18/24

(57) ABSTRACT

Systems and methods to verify a candidate assertion in an electronic content item are disclosed. In one aspect, embodiments of the present disclosure include a method, which may be implemented on a system, to identify, in an electronic content item, a candidate assertion to be fact verified, determine a verification strategy for the candidate assertion of the candidate assertion and/or evaluate the candidate assertion based on evidence data using the verification strategy. In some embodiments, the verification strategy can include a sequence of analyses to be performed on the evidence data, one or more of a tolerance parameter or a tolerance threshold, and/or one or more assertion types for candidate assertions.

### CLAIM OF PRIORITY

This application claims the benefit of U.S. Provisional Application No. 63/743,690, filed on Jan. 10, 2025, and entitled “System, Method, and Apparatus for Multi-Modal Data Verification and Analysis” (Docket No. 99810-8001.US00), the contents of which are incorporated herein by reference in their entirety.

### TECHNICAL FIELD

The disclosed technology generally relates to systems and methods to verify candidate assertions in electronic content items.

### BACKGROUND

Organizations increasingly rely on automated systems to generate, summarize, and transform large volumes of electronic content, including news stories, financial reports, regulatory filings, technical documentation, product descriptions, and conversational transcripts. Human review alone does not scale to the volume and velocity of such content. As a result, incorrect, outdated, or misleading factual statements can be published, replicated, and consumed before they are detected and corrected.

### BRIEF DESCRIPTION OF THE DRAWINGS

FIG. 1 illustrates an example block diagram of a host server in an environment able to verify candidate assertions in electronic content items over a network, in accordance with embodiments of the present disclosure.

FIG. 2A depicts an example user interface showing a project view with evaluation outputs including evaluation results for multiple candidate assertions in an electronic content item, in accordance with embodiments of the present disclosure.

FIG. 2B depicts an example user interface showing a fact-check reasoning view with evidence data and visualization of normalized evidence data for a candidate assertion, in accordance with embodiments of the present disclosure.

FIG. 2C depicts an example user interface showing evidence data reasoning including decomposition of a compound candidate assertion into multiple candidate assertions and identification of evidence sources, in accordance with embodiments of the present disclosure.

FIG. 2D depicts an example user interface showing equation reasoning including a sequence of analyses to be performed on evidence data for verifying a candidate assertion, in accordance with embodiments of the present disclosure.

FIG. 2E depicts an example user interface showing equation results reasoning including verification status and evaluation results for multiple candidate assertions, in accordance with embodiments of the present disclosure.

FIG. 2F depicts an example user interface showing a result of a fact-check including a document-level evaluation result based on evaluation results for multiple candidate assertions, in accordance with embodiments of the present disclosure.

FIG. 3A depicts an example functional block diagram of a host server 300 that facilitates verification of candidate assertions in electronic content items, in accordance with embodiments of the present disclosure.

FIG. 3B depicts an example block diagram illustrating the components of the host server 300 that facilitates verification of candidate assertions in electronic content items, in accordance with embodiments of the present disclosure.

FIG. 4A depicts an example functional block diagram of a client device 402 having capabilities to facilitate verification of candidate assertions in electronic content items, in accordance with embodiments of the present disclosure.

FIG. 4B depicts an example block diagram of a client device having capabilities to facilitate verification of candidate assertions in electronic content items, in accordance with embodiments of the present disclosure.

FIG. 5 depicts a flow chart illustrating an example process for verifying a candidate assertion in an electronic content item, in accordance with embodiments of the present disclosure.

FIG. 6 depicts a flow chart illustrating an example process for identifying multiple candidate assertions in an electronic content item, in accordance with embodiments of the present disclosure.

FIG. 7 depicts a flow chart illustrating an example process for determining a verification strategy for a candidate assertion, in accordance with embodiments of the present disclosure.

FIG. 8 depicts a flow chart illustrating an example process for selecting one or more evidence sources and/or retrieving evidence data for a candidate assertion, in accordance with embodiments of the present disclosure.

FIG. 9 depicts a flow chart illustrating an example process for evaluating a candidate assertion using evidence data and a verification strategy, in accordance with embodiments of the present disclosure.

FIG. 10A depicts a flow chart illustrating an example process for document-level evaluation, in accordance with embodiments of the present disclosure.

FIG. 10B depicts a flow chart illustrating an example process for generating evaluation records in accordance with embodiments of the present disclosure.

FIG. 11 is a block diagram illustrating an example of a software architecture that may be installed on a machine, in accordance with embodiments of the present disclosure.

FIG. 12 is a block diagram illustrating components of a machine, according to some example embodiments, able to read a set of instructions from a machine-readable medium and perform any one or more of the methodologies discussed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include systems, methods, and apparatuses for automated verification of factual claims in electronic content using artificial intelligence. The disclosed technology (e.g., a Fact-Checking Agent or FCA system) can provide a comprehensive and scalable solution for assessing the accuracy of information across diverse content types. In one embodiment, the system can receive and process natural-language text documents. In further embodiments, the system can also process structured data, multimedia content such as images, video, and audio, and source code or configuration files.

In one embodiment, the system can employ artificial intelligence techniques to identify, extract, and verify factual assertions within input content. Unlike traditional methods that may rely heavily on manual verification, the system can automate the fact-checking process using, for example, a combination of natural language processing, machine learning, and one or more reasoning methods. In some embodiments, the system can utilize one or more trained AI models, and can incorporate additional expert systems, algorithmic engines, and/or heuristic-driven capabilities in concert. This model-independent architecture can enable the system to leverage different AI models or combinations of models without altering the overall verification pipeline.

In one embodiment, the system can receive an electronic content item having natural-language text and can identify one or more candidate assertions in the electronic content item to be fact verified. A candidate assertion can include, for example, any factual claim, whether explicitly stated or implicitly derived from the content. Candidate assertions can include, for example, one or more of numeric claims, categorical claims, temporal claims, claims about entities or relationships, pricing claims, technical or scientific claims, historical claims, and forward-looking statements such as projections or forecasts. In some embodiments, the system can also distinguish between factual assertions and opinions, and can classify assertions by type, category, source, and/or verification status.

For each candidate assertion, the system can determine a verification strategy based at least in part on one or more properties of the candidate assertion. The verification strategy can specify, for example, which evidence sources to query, which reasoning methods to apply, and/or what tolerance thresholds to use when evaluating the assertion. In one embodiment, different assertion types can map to different verification strategies. For instance, a numeric claim may invoke mathematical verification with equation generation and solving, while an opinion-type assertion may focus on verifying source attribution and context rather than numeric accuracy. In a further embodiment, the system can perform methodology checking, verifying not only whether a stated value is correct but whether the methodology used to compute it conforms to expected standards or definitions.

In one embodiment, the system can select one or more evidence sources based at least in part on the verification strategy. Evidence sources can include, for example, one or more of structured databases, unstructured data repositories, knowledge graphs, APIs, web resources, real-time data streams, sensor networks and telemetry feeds, proprietary or user-provided data, and/or external research or citation agents. In some embodiments, the system can integrate with other specialized AI agents, such as a Citation Agent for finding and providing citations for sources and/or a Research Assistant Agent for conducting automated research in online and offline data sources. In a further embodiment, evidence source selection can be influenced by personalized fact-checking profiles that can encode user or organization preferences, including, for example, preferred data sources, source rankings, and/or domain-specific rules.

In one embodiment, the system can retrieve evidence data from the one or more evidence sources and can normalize the evidence data to a canonical representation prior to evaluation. Normalization can include, for example, one or more of converting numeric values expressed in different units or currencies into a common unit or currency, aligning metrics from different reporting periods into a common comparison period, and/or mapping different textual category labels into a shared taxonomy.

In one embodiment, the system can evaluate each candidate assertion based at least in part on the evidence data and the verification strategy to determine an evaluation result. Evaluation can employ one or more reasoning methods, which can include, for example, agentic AI reasoning using large language models, application of heuristics or rule-based systems, mathematical verification through equation generation and solving, logical inference, statistical analysis, pattern recognition, and/or theorem proving or constraint satisfaction for assertions that may require formal logical proof. In some embodiments, for assertions that may not have a single true or false answer, the system can apply fuzzy logic or probabilistic methods to represent gradations of truth within a given context or reference frame. In a further embodiment, the system can perform consistency checking across multiple related assertions in a document or collection of documents to verify logical consistency and/or identify contradictions or missing elements.

In one embodiment, the evaluation result for a candidate assertion can include, for example, a verification status selected from among supported, contradicted, not verifiable, or uncertain. The system can compute a confidence score to indicate a likelihood that the verification status is correct, and can compare the confidence score to one or more tolerance thresholds to assess the verification status. In some embodiments, tolerance thresholds can be determined based on, for example, the assertion type, user or organization preferences, and/or configurable policies. In a further embodiment, the system can support adjustable grounding reference frames that can define which models and data sources should be preferred or excluded for particular categories of assertions, enabling the system to adapt to, for example, different belief systems, regulatory contexts, or organizational requirements.

In one embodiment, for each candidate assertion, the system can generate an evaluation record that includes the evaluation result and/or one or more identifiers of the evidence data used to determine the evaluation result. The system can generate an output including the electronic content item and/or display data corresponding to the evaluation record, such as, for example, visualizations, charts, or graphs that can present the reasoning and evidence. In some embodiments, when the evaluation result indicates contradiction or uncertainty, the system can generate a modified version of the electronic content item in which text associated with the candidate assertion is annotated or rewritten to reflect the verified information.

In one embodiment, the system can determine document-level evaluation results and/or verification metrics based on evaluation results for multiple candidate assertions in an electronic content item, and can rank sections of the electronic content item based on the verification statuses of the candidate assertions. In a further embodiment, the system can support both static fact-checking, where the content and result are fixed at a point in time, and dynamic fact-checking, where the system can monitor changing data streams and can periodically re-verify assertions as underlying data is updated.

In one embodiment, the system can present evaluation results to a user and can receive user feedback indicating a confirmation or override of the evaluation result. User feedback can be used to adjust tolerance thresholds or parameters of the verification strategy, enabling the system to learn from feedback and improve future verification accuracy. In some embodiments, feedback can be captured from individual users or aggregated across multiple users to support community-based fact-checking. In a further embodiment, the system can provide interactive interfaces that can allow users to explore the fact-checking process and evidence, drill into reasoning steps, filter by evidence source, and/or navigate to underlying source documents.

In one embodiment, the system can store previously verified assertions and associated evidence data in a knowledge base repository. When evaluating a new candidate assertion, the system can retrieve matching evidence data from the knowledge base, which can avoid redundant computation and can leverage prior verification work. In some embodiments, the knowledge base can support permissions such that records are accessible only to authorized users or organizations, enabling different fact-bases for different contexts.

In one embodiment, the system can expose an application programming interface to receive requests specifying electronic content items or streams or batches of electronic content items, and can return evaluation results for candidate assertions in response to the requests. This can enable fact-checking as a service for integration with other software applications and platforms. In some embodiments, the system can evaluate candidate assertions in a stream of electronic content items as the stream is received, and can schedule evaluation of batches of electronic content items with generation of batch verification metrics.

In various embodiments, the system can have applications including, for example, one or more of fact-checking news articles, social media posts, and online content; verifying reports and due diligence materials; ensuring the factual integrity of legal documents, scientific publications, and educational materials; verifying assertions embedded in source code, configuration files, and technical documentation; and/or enhancing the reliability of information used in business decision-making and strategic planning.

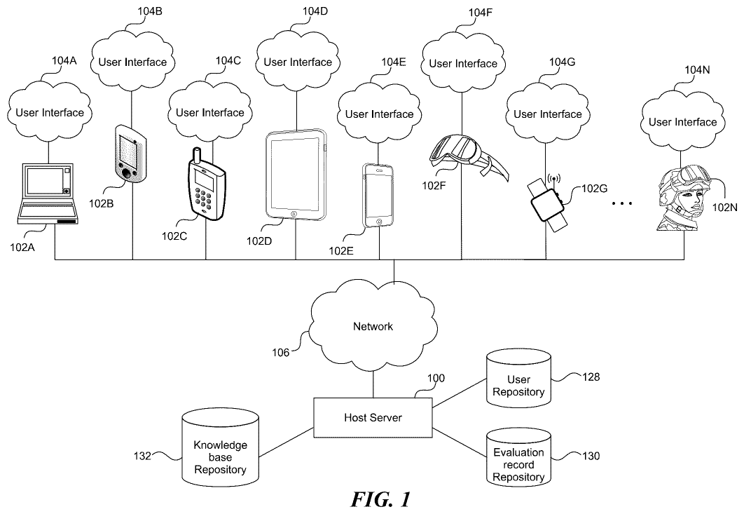

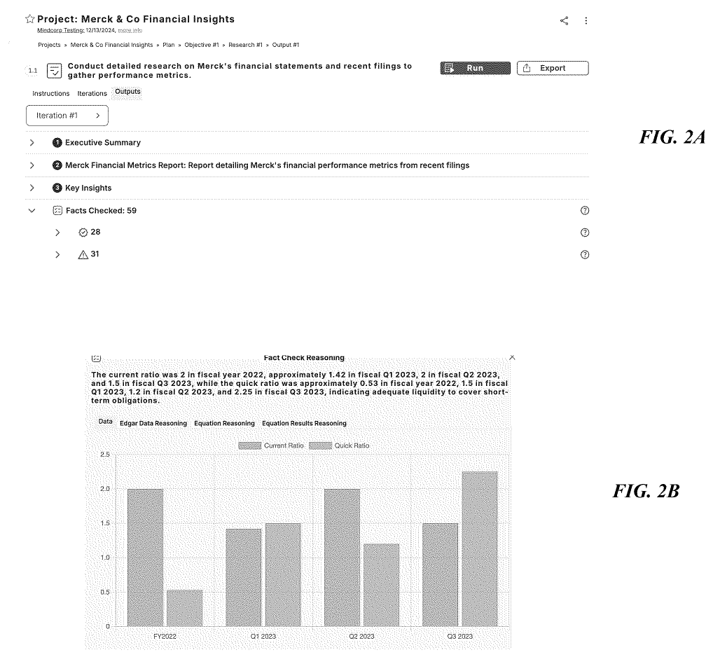

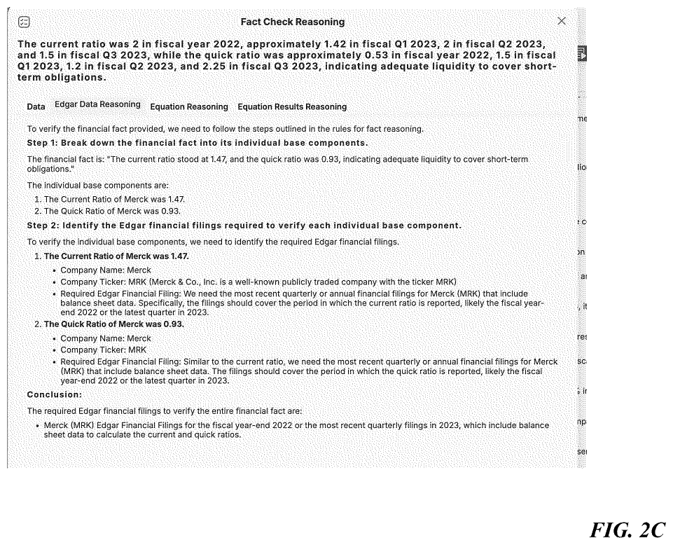

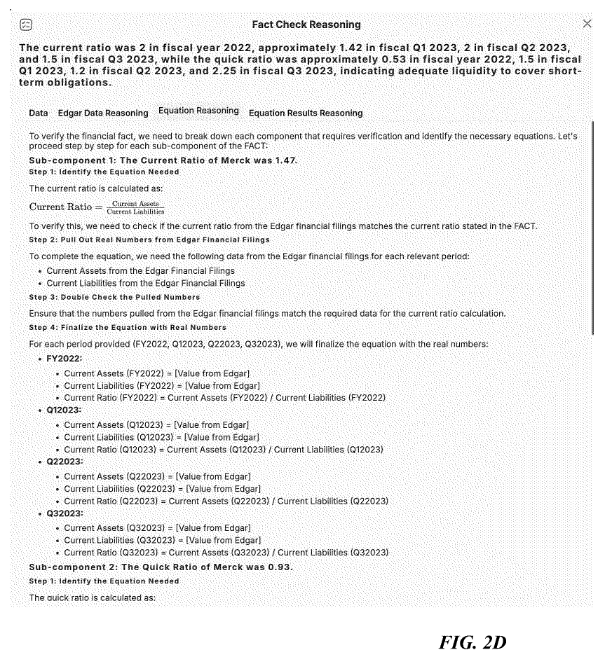

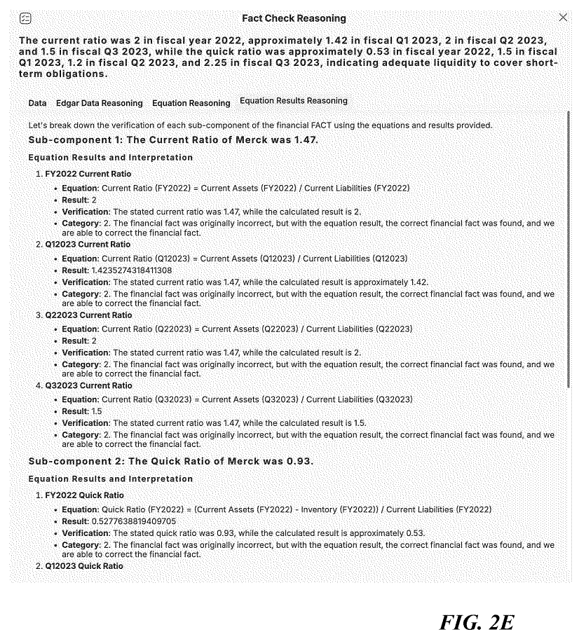

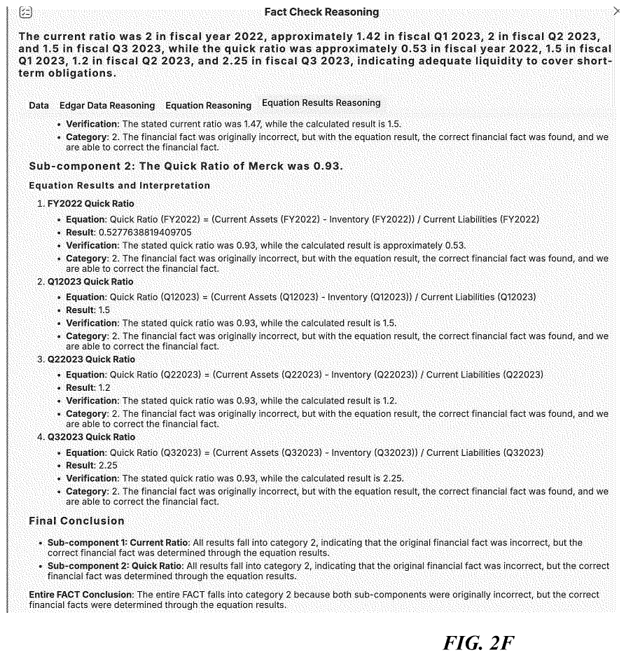

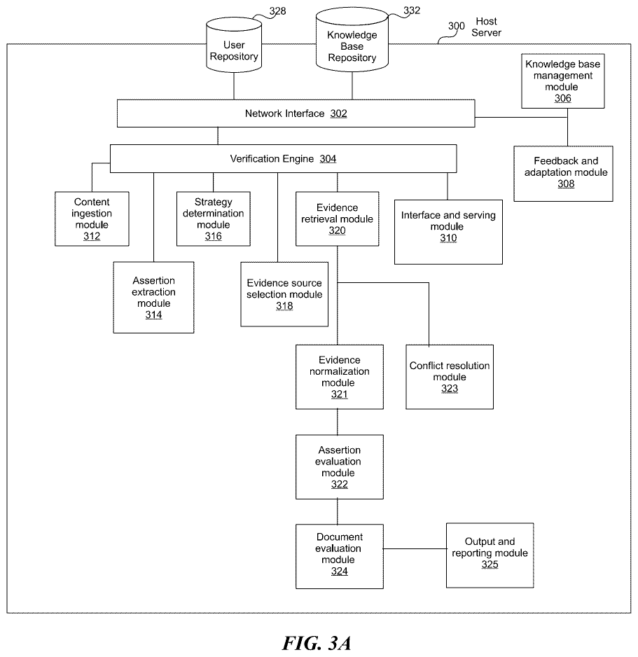

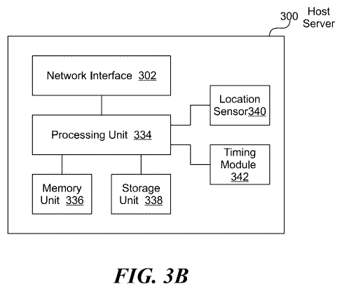

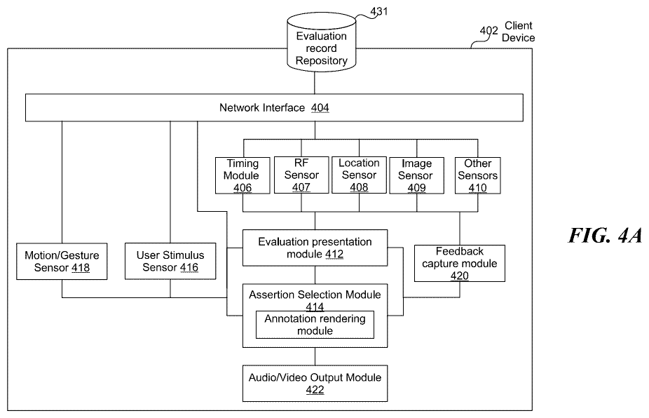

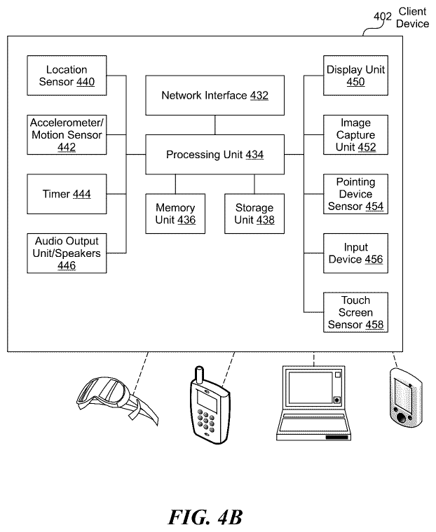

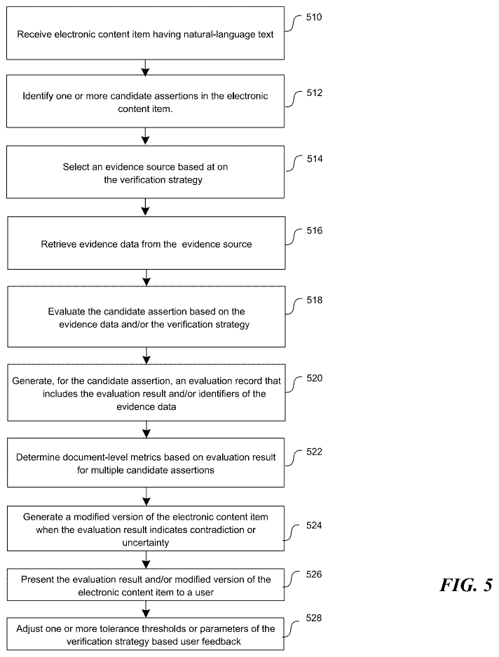

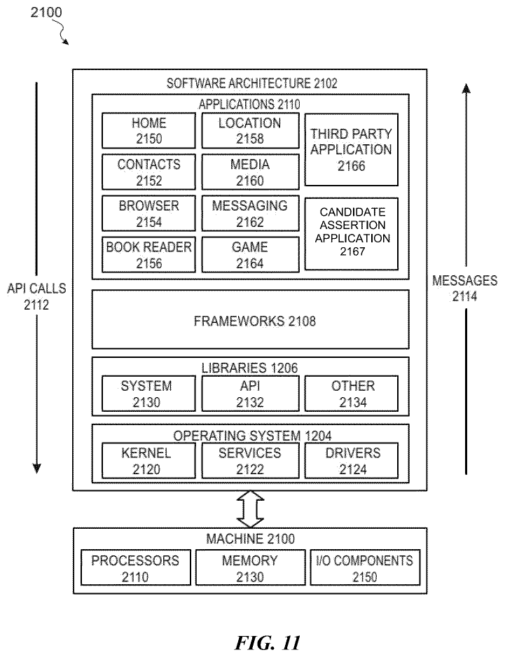

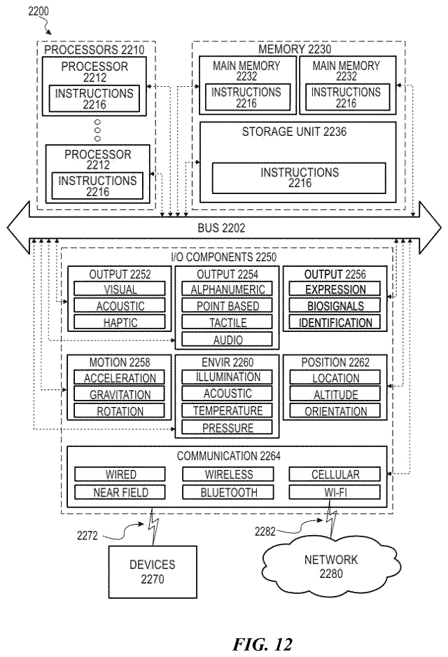

The following figures and accompanying descriptions provide additional detail regarding example embodiments of the disclosed technology. FIG. 1 illustrates an example network environment including a host server and client devices. FIGS. 2A-2F depict example user interface screenshots illustrating fact-check workspaces, reasoning views, and evaluation results. FIGS. 3A-3B depict example block diagrams of a host server including a verification engine and associated modules. FIGS. 4A-4B depict example block diagrams of a client device. FIGS. 5-10B depict flow charts illustrating example processes for candidate assertion verification, strategy determination, evidence retrieval, assertion evaluation, document-level processing, and user feedback handling. FIGS. 11-12 depict example software architecture and machine components.

FIG. 1 illustrates an example block diagram of a host server 100 in an environment able to verify candidate assertions in electronic content items over a network, in accordance with embodiments of the present disclosure.

The client devices 102A-102G can be any system and/or device, and/or any combination of devices/systems that is able to establish a connection with another device, a server, and/or other systems. Client devices 102A-102G each typically include a display and/or other output functionalities to present information and data exchanged between the devices 102A-102G and the host server 100.

For example, the client devices 102A-102G can include mobile, handheld, or portable devices or non-portable devices and can be any of, but not limited to, a server desktop, a desktop computer, a computer cluster, or portable devices including a notebook, a laptop computer, a handheld computer, a palmtop computer, a mobile phone, a cell phone, a smartphone, a PDA, a handheld tablet (e.g., an iPad, a Galaxy, Xoom Tablet, etc.), a tablet PC, a thin-client, a handheld console, a handheld gaming device or console, an iPhone, a wearable device, a head-mounted device, a smartwatch, goggles, smart glasses, a smart contact lens, and/or any other portable, mobile, handheld devices, etc. The input mechanism on client devices 102A-102G can include a touch screen keypad (including single touch, multi-touch, gesture sensing in 2D or 3D, etc.), a physical keypad, a mouse, a pointer, a trackpad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), eye tracking, eye detection, pupil tracking/detection, or a combination of the above.

The client devices 102A-102G can each include a user interface 104A-104N. The user interfaces 104A-104N can include graphical user interfaces, web interfaces, native application interfaces, or other presentation layers configured to display electronic content items, candidate assertions, evaluation results, and verification metrics, and to receive user actions such as content submissions, review decisions, feedback, or confirmations and overrides of evaluation results.

The client devices 102A-102G and the host server 100 can be coupled to the network 106 and/or multiple networks. In some embodiments, the client devices 102A-102G and/or the host server 100 may be directly connected to one another.

In one embodiment, the host server 100 is operable to verify candidate assertions in electronic content items (e.g., as further described with reference to the verification engine 304 of FIG. 3A and the user interface elements of FIGS. 2A-2F). The host server 100 can receive an electronic content item from a client device 102A-102G, identify one or more candidate assertions in the electronic content item, determine a verification strategy for each candidate assertion based at least in part on one or more properties of the candidate assertion, select one or more evidence sources based at least in part on the verification strategy, retrieve evidence data from the one or more evidence sources, and evaluate each candidate assertion based at least in part on the evidence data and the verification strategy to determine an evaluation result for the candidate assertion. The host server 100 can generate evaluation records, document-level verification metrics, and modified versions of electronic content items, and can provide such outputs to the client devices 102A-102G for presentation via the user interfaces 104A-104N.
In one embodiment, the disclosed framework includes systems and processes for verifying candidate assertions in electronic content items. Example components of the framework can include:
Client applications (e.g., mobile applications, web applications, browser extensions, desktop applications, etc.)
Servers and namespaces (e.g., the host server 100 can host verification services and namespaces; the electronic content items, verification policies, and evidence source configurations can be created by users 116A-N and/or third-party content providers)
Verification services (e.g., the host server 100 can run a verification engine through the platform to evaluate candidate assertions in electronic content items submitted via an API or user interface)
Search and discovery (e.g., the host server 100 can facilitate search and discovery of evaluation records, evidence data, and verification metrics across electronic content items and projects)
Identities and relationships (e.g., the host server 100 can manage user accounts, roles, permissions, and relationships between users 116A-N, and can track user feedback and preferences)

Functions and techniques performed by the host server 100 and the components therein are described in detail with further references to the examples of FIG. 3A-3B.

In general, network 106, over which the client devices 102A-102N and the host server 100 communicate, may be a telephonic network, a cellular network, an open network such as the Internet, or a private network such as an intranet and/or an extranet, or any combination thereof. For example, the Internet can provide file transfer, remote log in, email, news, RSS, cloud-based services, instant messaging, visual voicemail, push mail, VoIP, and other services through any known or convenient protocol, such as, but not limited to, the TCP/IP protocol, Open System Interconnections (OSI), FTP, UPnP, iSCSI, NFS, ISDN, PDH, RS-232, SDH, SONET, etc.

The network 106 can be any collection of distinct networks operating wholly or partially in conjunction to provide connectivity to the client devices 102A-102N and the host server 100 and may appear as one or more networks to the serviced systems and devices. In one embodiment, communications to and from the client devices 102A-102N can be achieved by an open network, such as the Internet, or a private network, such as an intranet and/or an extranet. In one embodiment, communications can be achieved by a secure communications protocol, such as secure sockets layer (SSL) or transport layer security (TLS).

In addition, communications can be achieved via one or more networks, such as, but not limited to, one or more of WiMax, a Local Area Network (LAN), Wireless Local Area Network (WLAN), a Personal Area Network (PAN), a Campus Area Network (CAN), a Metropolitan Area Network (MAN), a Wide Area Network (WAN), a Wireless Wide Area Network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General Packet Radio Service (GPRS), enhanced GPRS, iBurst, UMTS, HSDPA, HSUPA, HSPA, UMTS-TDD, 1×RTT, EV-DO, messaging protocols such as TCP/IP, SMS, MMS, extensible messaging and presence protocol (XMPP), real-time messaging protocol (RTMP), instant messaging and presence protocol (IMPP), instant messaging, USSD, IRC, or any other wireless data networks or messaging protocols.

The host server 100 may include internally, or be externally coupled to, a user repository 128, an evaluation record repository 130, and/or a knowledge base repository 132. The repositories can store software, descriptive data, evaluation records, evidence data, system information, and/or any other data item utilized by other components of the host server 100 and/or any of the client devices 102A-102G for operation. The repositories may be managed by a database management system (DBMS), for example, but not limited to, Oracle, DB2, Microsoft Access, Microsoft SQL Server, PostgreSQL, MySQL, FileMaker, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to generate, create, and/or provide data to be stored in the user repository 128, the evaluation record repository 130, and/or the knowledge base repository 132. The user repository 128 can store user information, user profile information, user preferences, personalized fact-checking profiles, authentication credentials, roles and permissions, historical feedback on evaluation results, and/or analytics and statistics regarding user interactions with evaluation results.

The evaluation record repository 130 can store evaluation records for candidate assertions and electronic content items. The evaluation record repository 130 can store evaluation results, verification statuses, confidence scores, tolerance thresholds applied, identifiers of evidence data used during evaluation, document-level verification metrics, and/or any other data associated with the evaluation of candidate assertions. The evaluation record repository 130 can also store candidate assertion signatures that can be used to identify previously evaluated candidate assertions and to retrieve cached evaluation results when the same or a similar candidate assertion is encountered again.

The knowledge base repository 132 can store evidence data retrieved from one or more evidence sources, normalized to a canonical representation. The knowledge base repository 132 can store, for example, structured entity records (e.g., companies, instruments, locations, people), canonical values for key metrics, historical time series for numeric indicators, taxonomy mappings, and/or links to external authoritative sources. The knowledge base repository 132 can also store verification policies, grounding reference frames, tolerance threshold configurations, and/or evidence source rankings that can be applied when determining verification strategies for candidate assertions.

In one embodiment, the host server 100 can expose an application programming interface (API) to receive requests specifying an electronic content item, a stream of electronic content items, and/or a batch of electronic content items, and can return evaluation results for candidate assertions in response to the request. The host server 100 can evaluate candidate assertions in a stream of electronic content items as the stream is received, and/or can schedule evaluation of a batch of electronic content items and generation of batch verification metrics across the batch of electronic content items.

The components shown in FIG. 1 are illustrative only. In other embodiments, the environment can include additional client devices, servers, and data sources; components can be combined or omitted; and the functionality described herein can be partitioned across components in different ways. For example, certain assertion extraction or evidence retrieval logic can execute on a client device 102A-102N, while other portions of the verification pipeline execute on the host server 100 or on separate backend services.

In some embodiments, the system (e.g., the host server 100 of FIG. 1 and/or the host server 300 of FIGS. 3A-3B and/or the device 102A-N as shown in the example of FIG. 1 and/or the device 402 of the example of FIG. 4A) provides a client application that presents user interfaces for managing electronic content items, viewing candidate assertions, and inspecting evaluation results and underlying evidence data. Examples of such user interfaces are illustrated in FIGS. 2A-2F.

FIG. 2A depicts an example user interface showing a project view with evaluation outputs including evaluation results for multiple candidate assertions in an electronic content item, in accordance with embodiments of the present disclosure.

In one embodiment, the example of the user interface shown in FIG. 2A can be presented on a client device (e.g., the device 102A-102N of FIG. 1 and/or the device 402 of FIG. 4A). The example of the user interface can include a project-level dashboard view (e.g., a workspace view) that can depict, display, or identify one or more electronic content items and/or one or more candidate assertions (e.g., factual claims) that have been extracted from the one or more electronic content items. In one embodiment, the one or more candidate assertions can be extracted by an assertion extraction module (e.g., the assertion extraction module 314 executing on the host server 300).

The example of the user interface shown in FIG. 2A can further include a list of entries corresponding to candidate assertions that have been identified in the one or more electronic content items. For each entry in the list, the example of the user interface can display, depict, or present the text of the candidate assertion and/or one or more graphical indicators (e.g., colored icons, badges, or labels) corresponding to an evaluation result and/or a verification status for the candidate assertion. The verification status can indicate, for example, whether the candidate assertion is supported, contradicted, not verifiable, or uncertain. In some embodiments, the example of the user interface can also display or depict a confidence score that indicates a likelihood that the verification status is correct.

In one embodiment, the evaluation result and/or the verification status for each candidate assertion can be determined by an assertion evaluation module (e.g., the assertion evaluation module 322 executing on the host server 300) based at least in part on evidence data that has been retrieved from one or more evidence sources and/or on a verification strategy that has been determined for the candidate assertion by a strategy determination module (e.g., the strategy determination module 316). The verification strategy can be determined based at least in part on one or more properties of the candidate assertion. For example, an assertion type of the candidate assertion (e.g., numeric, categorical, temporal, or opinion) can influence the verification strategy and/or the one or more evidence sources that are selected.

For example, the list shown in the example of FIG. 2A can include an entry for a sentence such as “Company A's revenue increased by 10% year-over-year in 2023” (e.g., a candidate assertion in an electronic content item to be fact verified). After the system (e.g., the host server 100 of FIG. 1 and/or the host server 300 of FIGS. 3A-3B) evaluates the candidate assertion, the example of the user interface can display or depict a status icon or graphical indicator indicating that the candidate assertion is, for example, supported with high confidence or contradicted based on evidence data that has been retrieved from one or more evidence sources.

In a further embodiment, the example of the user interface shown in FIG. 2A can include one or more summary panels or widgets (e.g., project-level summary views) that can display, depict, or present one or more document-level evaluation results and/or one or more verification metrics for an electronic content item. The one or more verification metrics can include, for example, counts or percentages of candidate assertions in each verification status. In one embodiment, a document evaluation module (e.g., the document evaluation module 324 executing on the host server 300) can determine a verification metric for an electronic content item based on verification statuses of multiple candidate assertions in the electronic content item and/or can rank sections of the electronic content item based on the verification statuses of the multiple candidate assertions. The one or more document-level evaluation results, verification metrics, or rankings can be rendered or depicted as summary cards or charts in the example of the user interface shown in FIG. 2A.

In some embodiments, a user can select any entry corresponding to a candidate assertion that is displayed in the example of FIG. 2A using input controls of the client device (e.g., the device 402). For example, when the user selects an entry corresponding to a candidate assertion such as “Company A's revenue increased by 10% year-over-year in 2023,” the system (e.g., the host server 300 and/or the device 402) can retrieve an evaluation record associated with the candidate assertion and can present or display a detail view as shown in the example of FIG. 2B. The evaluation record can be a data structure that includes the evaluation result, the verification status, and/or one or more identifiers of evidence data that was used to determine the evaluation result for the candidate assertion.

In a further embodiment, the example of the user interface shown in FIG. 2A can enable a user to interactively explore, navigate among, filter, or search candidate assertions, evaluation results, and/or underlying evidence data. For example, the user can expand or collapse sections, filter by verification status or assertion type, or drill down into detail views for individual candidate assertions.

FIG. 2B depicts an example user interface showing a fact-check reasoning view with evidence data and visualization of normalized evidence data for a candidate assertion, in accordance with embodiments of the present disclosure.

In one embodiment, the example of the user interface shown in FIG. 2B can be presented on a client device (e.g., the device 102A-102N of FIG. 1 and/or the device 402 of FIG. 4A) and can be generated by the system (e.g., a fact-checking system or FCA, such as the host server 100 of FIG. 1 and/or the host server 300 of FIGS. 3A-3B) using an interface and serving module (e.g., the interface and serving module 310).

In the example of FIG. 2B, a candidate assertion (e.g., a factual claim) that has been selected is a sentence from an electronic content item having natural-language text (e.g., input content, a document), such as “Company A's revenue increased by 10% year-over-year in 2023.” This sentence can be treated by the system as a candidate assertion in the electronic content item to be fact verified.

An upper portion of the example of the user interface shown in FIG. 2B can display or depict the text of the candidate assertion together with an evaluation result and/or a verification status that indicates how the system evaluated the candidate assertion. For example, the system can determine that the candidate assertion is supported, contradicted, not verifiable, or uncertain, and/or can compute a confidence score that indicates a likelihood that the verification status is correct. These values can be generated by an assertion evaluation module (e.g., the assertion evaluation module 322 executing on the host server 300) based at least in part on evidence data and/or a verification strategy that has been determined for the candidate assertion.

The example of the user interface shown in FIG. 2B can further include a reasoning panel (e.g., a human-readable explanation view) that can display, depict, or present an explanation derived from an evaluation record (e.g., a fact-check report) for the candidate assertion. The evaluation record can be a data structure that is generated by an output and reporting module (e.g., the output and reporting module 325) and can include the evaluation result, the verification status, one or more identifiers of evidence data that was used to determine the evaluation result, and/or explanation data.

In one embodiment, the example of the user interface shown in FIG. 2B can display or depict that the system identified the sentence as a numeric assertion about year-over-year revenue growth (e.g., the assertion type), resolved “Company A” to a canonical entity identifier, selected one or more evidence sources (e.g., a regulatory filing system such as EDGAR, a financial database, or other evidence sources) based at least in part on the verification strategy, retrieved revenue values for 2022 and 2023 (e.g., the evidence data), and/or computed the year-over-year growth rate as part of a sequence of analyses specified in the verification strategy. In a further embodiment, the system can normalize financial time periods across multiple entities (e.g., fiscal calendar normalization) to enable accurate comparison of evidence data even when the entities have different fiscal year-ends.

The example of the user interface shown in FIG. 2B can further include a set of tabs or navigation controls (e.g., user interface tabs) that can enable a user to access, view, or inspect different components of the evaluation record and/or the underlying evidence data. In one embodiment, the tabs can enable a user to interactively explore the fact-checking process and/or the evidence data (e.g., by expanding, collapsing, filtering, or drilling down into different portions of the evaluation record).

In the example shown in FIG. 2B, a “Fact Check Reasoning” tab is active. When this tab is selected, the system (e.g., the host server 300 executing the verification engine 304 and/or the interface and serving module 310) can cause the client device 402 to display or depict both narrative reasoning and/or a visualization of evidence data that was used to evaluate the candidate assertion.

In some embodiments, the “Fact Check Reasoning” tab can include a chart (e.g., a visualization of evidence data) that can display or depict values across reporting periods for an entity that has been resolved to a canonical entity identifier. For example, for the candidate assertion “Company A's revenue increased by 10% year-over-year in 2023,” the chart can display bars or points corresponding to Company A's revenue in 2022 and/or Company A's revenue in 2023, as retrieved by an evidence retrieval module (e.g., the evidence retrieval module 320) from one or more evidence sources that have been selected by an evidence source selection module (e.g., the evidence source selection module 318). The values shown in the chart can correspond to evidence data that has been retrieved from the one or more evidence sources and that the assertion evaluation module 322 can use when applying a verification strategy to compute a year-over-year growth rate and/or compare that growth rate to the “10%” stated in the candidate assertion. The chart can enhance understanding and/or transparency by presenting complex evidence data clearly and/or concisely.

In addition to the chart, the “Fact Check Reasoning” tab can display or depict narrative explanation that ties the evidence data that has been visualized directly to the evaluation result. For example, the explanation can indicate that Company A's revenue for 2022 was a first value (e.g., evidence data for a first period), Company A's revenue for 2023 was a second value (e.g., evidence data for a second period), and/or that the ratio (e.g., second value minus first value divided by the first value) corresponds to an observed growth rate that is compared to the claimed 10% growth. The explanation can further indicate that the observed growth rate matches the claimed increase within a tolerance threshold or falls outside a tolerance threshold (e.g., a tolerance threshold associated with the verification strategy), and/or that this comparison determines whether the candidate assertion is classified as supported or contradicted (e.g., the verification status). In one embodiment, a tolerance threshold or a tolerance parameter can be determined based at least in part on an assertion type of the candidate assertion or on a policy.

The example of the user interface shown in FIG. 2B can also display or depict additional information from the evaluation record, such as a link or control to view identifiers of the underlying evidence data (for example, filing identifiers, reporting periods, or dataset identifiers that were used as evidence sources), and/or a control to navigate to more detailed views in other tabs. The other tabs can include, for example, a “Data” tab (e.g., an evidence data view), an “EDGAR Data Reasoning” tab (e.g., an evidence-source reasoning view), an “Equation Reasoning” tab (e.g., a sequence of analyses view), and/or an “Equation Results Reasoning” tab (e.g., equation outputs and/or a detailed evaluation result view).

In some embodiments, when the “Data” tab is selected, the example of the user interface can display or depict a table of records (e.g., evidence data entries), where each record can correspond to a value for a specific metric, reporting period, and/or entity. For example, the table can include rows for Company A's revenue in 2022 and/or Company A's revenue in 2023. Each row can include one or more of: a metric name (e.g., “Revenue”), a numeric value, a reporting period (e.g., fiscal year 2022 or fiscal year 2023), and/or a link or identifier for a source document such as a regulatory filing (e.g., an annual report or a quarterly report). These values can be examples of evidence data that has been retrieved from one or more evidence sources.

In a further embodiment, the evidence data displayed in the “Data” tab can be evidence data that has been transformed into a canonical representation by an evidence normalization module (e.g., the evidence normalization module 321). The canonical representation can include one or more of: numeric values that have been converted from different units or currencies into a common unit or currency, financial metrics from different financial reporting periods that have been aligned into a common comparison period, and/or different textual category labels that have been mapped into a shared taxonomy. This can correspond to normalizing the evidence data to a canonical representation as described in the method claims.

The records displayed in the “Data” tab can also include source identifiers (e.g., identifiers of the evidence data), such as filing identifiers, document citations, or dataset identifiers. The output and reporting module 325 can store these identifiers alongside the evaluation result in the evaluation record so that the system can later reconstruct and/or present the evidence data that was used to evaluate the candidate assertion.

In some embodiments, when the user switches tabs, the client device 402 can send a request to the host server 300, which can then retrieve appropriate portions of the evaluation record and/or the evidence data from an evaluation record repository (e.g., the evaluation record repository 130) and can cause those portions to be rendered or depicted in the tab that has been selected.

Thus, the example of FIG. 2B illustrates an embodiment in which the system can present, for a single candidate assertion in an electronic content item, an explanation view that combines the evaluation result and/or the verification status, a narrative explanation, and/or a chart of evidence data that was used to evaluate the candidate assertion according to a verification strategy. The example of the user interface shown in FIG. 2B can provide detailed explainability and/or transparency, enabling a user to understand the basis for the system's conclusions.

FIG. 2C depicts an example of a user interface showing evidence source reasoning including decomposition of a compound candidate assertion into multiple candidate assertions and/or identification of one or more evidence sources, in accordance with embodiments of the present disclosure.

In one embodiment, the example of the user interface shown in FIG. 2C can illustrate an “EDGAR Data Reasoning” tab of a detail view for a candidate assertion. In the example shown, the candidate assertion is a compound statement about current ratio and quick ratio values across multiple reporting periods. The example of the user interface shown in FIG. 2C can be presented on a client device (e.g., the device 102A-102N of FIG. 1 and/or the device 402 of FIG. 4A) and/or can be generated by the system (e.g., the host server 300 via the interface and serving module 310).

The example of the user interface shown in FIG. 2C can display or depict a step-by-step explanation describing how the system (e.g., via the strategy determination module 316 and/or the evidence source selection module 318) reasons about verifying the candidate assertion. In one embodiment, the reasoning can include one or more steps for decomposing the candidate assertion into multiple candidate assertions and/or one or more steps for identifying evidence sources required to verify each of the multiple candidate assertions.

In a further embodiment, the example of the user interface shown in FIG. 2C can display or depict that a compound candidate assertion has been decomposed into multiple candidate assertions (e.g., atomic facts or sub-components). For example, a compound statement such as “The current ratio stood at 1.47, and the quick ratio was 0.93, indicating adequate liquidity to cover short-term obligations” can be decomposed into a first candidate assertion about current ratio (e.g., “The Current Ratio of Merck was 1.47”) and/or a second candidate assertion about quick ratio (e.g., “The Quick Ratio of Merck was 0.93”). This decomposition can enable more granular verification, can enable the system to pinpoint specific inaccuracies within complex candidate assertions, and/or can provide a more nuanced understanding of the overall veracity of a compound statement.

For each of the multiple candidate assertions (e.g., sub-components), the example of the user interface shown in FIG. 2C can display or depict information used to identify one or more evidence sources. For example, for a candidate assertion about current ratio, the example of the user interface can display or depict a company name (e.g., “Merck”), a company ticker symbol (e.g., “MRK”), and/or a description of required filings (e.g., quarterly or annual financial filings that include balance sheet data for the relevant reporting periods).

In one embodiment, the example of the user interface shown in FIG. 2C can display or depict that the system resolved an entity referenced in the candidate assertion (e.g., “Merck”) to a canonical entity identifier (e.g., a ticker symbol or other unique identifier) and/or selected one or more evidence sources based at least in part on the canonical entity identifier. The evidence source selection module 318 can select one or more filings from an external filing repository (e.g., one or more evidence sources such as an EDGAR database) based at least in part on the canonical entity identifier, the assertion type, and/or the verification strategy.

In some embodiments, the evidence source selection module 318 can rank the one or more evidence sources based at least in part on one or more of source reliability, recency, or domain coverage, and/or can select which filings are most appropriate for retrieving the evidence data. The example of the user interface shown in FIG. 2C can list or display one or more selected filings and/or can describe why each filing was chosen. For example, the example of the user interface can indicate that the system requires “Merck (MRK) Edgar Financial Filings for the fiscal year-end 2022 or the most recent quarterly filings in 2023, which include balance sheet data to calculate the current and quick ratios.”

In a further embodiment, the example of the user interface shown in FIG. 2C can display or depict information about fiscal calendar normalization. For example, when comparing evidence data across multiple entities that have different fiscal year-ends, the system can automatically determine each entity's fiscal year start date and/or can adjust financial report dates accordingly, enabling accurate comparisons and/or calculations.

The reasoning steps and/or evidence source identifiers displayed in the example of FIG. 2C can form part of the evaluation record generated by the output and reporting module 325 and/or can be stored in an evaluation record repository (e.g., the evaluation record repository 130), enabling the system and/or the user to trace how the candidate assertion was decomposed and/or mapped to one or more evidence sources.

In one embodiment, the example of the user interface shown in FIG. 2C can enable a user to interactively explore the evidence source reasoning (e.g., by expanding, collapsing, or drilling down into individual reasoning steps, sub-components, or evidence source identifiers).

FIG. 2D depicts an example of a user interface showing equation reasoning including a sequence of analyses to be performed on evidence data for verifying a candidate assertion, in accordance with embodiments of the present disclosure.

In one embodiment, the example of the user interface shown in FIG. 2D can illustrate an “Equation Reasoning” tab of a detail view for a candidate assertion. In the example shown, the candidate assertion is a compound statement about current ratio and quick ratio values across multiple reporting periods, which has been decomposed into multiple candidate assertions (e.g., sub-components) as described with reference to FIG. 2C. The example of the user interface shown in FIG. 2D can be presented on a client device (e.g., the device 102A-102N of FIG. 1 and/or the device 402 of FIG. 4A) and/or can be generated by the system (e.g., the host server 300 via the interface and serving module 310).

The example of the user interface shown in FIG. 2D can display or depict a sequence of analyses (e.g., a sequence of analyses specified in a verification strategy) that the system can apply to evidence data to evaluate the candidate assertion. In one embodiment, the strategy determination module 316 can classify the candidate assertion as a numeric comparison involving financial ratios, and/or can determine a verification strategy that includes one or more equations for computing observed ratio values based on evidence data that has been retrieved from one or more evidence sources.

For each of the multiple candidate assertions (e.g., sub-components), the example of the user interface shown in FIG. 2D can display or depict one or more steps for verifying the sub-component. For example, for a first sub-component such as “The Current Ratio of Merck was 1.47,” the example of the user interface can display or depict:

A step to identify an equation needed to verify the sub-component (e.g., “Step 1: Identify the Equation Needed”). The example of the user interface can display or depict that current ratio is calculated as Current Assets divided by Current Liabilities.

A step to identify evidence data required to complete the equation (e.g., “Step 2: Pull Out Real Numbers from Edgar Financial Filings”). The example of the user interface can display or depict that Current Assets and/or Current Liabilities are needed from the one or more evidence sources for each relevant reporting period.

A step to verify that the evidence data matches required data for the calculation (e.g., “Step 3: Double Check the Pulled Numbers”).

A step to finalize the equation with actual values from the evidence data (e.g., “Step 4: Finalize the Equation with Real Numbers”). The example of the user interface can display or depict, for each reporting period (e.g., FY2022, Q12023, Q22023, Q32023), the values for Current Assets, Current Liabilities, and/or the resulting Current Ratio calculation.

In one embodiment, the example of the user interface shown in FIG. 2D can display or depict one or more equations, such as an equation defining current ratio (e.g., Current Ratio=Current Assets/Current Liabilities) and/or an equation defining quick ratio (e.g., Quick Ratio=(Current Assets-Inventory)/Current Liabilities). For each equation, the example of the user interface can display or depict explanatory text mapping equation variables to specific entries in the evidence data.

In a further embodiment, the example of the user interface shown in FIG. 2D can display or depict that the system verifies not only the final value but also the methodology used to compute the value (e.g., methodology checking). For example, the system can verify that a stated current ratio was computed using a standard methodology (e.g., Current Assets divided by Current Liabilities) and/or can identify whether a non-standard methodology was used.

The example of the user interface shown in FIG. 2D can also display or depict intermediate quantities (e.g., intermediate evaluation results), such as the values of Current Assets and/or Current Liabilities for each reporting period before the ratio is computed. These intermediate quantities can correspond to internal results generated by the assertion evaluation module 322 as it executes the sequence of analyses defined in the verification strategy.

In some embodiments, the sequence of analyses can be determined at least in part from an assertion type of the candidate assertion. For example, a numeric assertion about financial ratios can have a different sequence of analyses than a categorical assertion or a temporal assertion.

By presenting the equations, variable mappings, and/or intermediate quantities, the example of FIG. 2D can provide a transparent view into how the system transforms evidence data into computed metrics as part of evaluating the candidate assertion. The equations, variable mappings, and/or intermediate results displayed in the example of FIG. 2D can be stored in, or derived from, the evaluation record for the candidate assertion.

In one embodiment, the example of the user interface shown in FIG. 2D can enable a user to interactively explore the equation reasoning (e.g., by expanding, collapsing, or drilling down into individual equations, variables, or intermediate results).

FIG. 2E depicts an example of a user interface showing equation results reasoning including intermediate evaluation results and/or verification status for multiple candidate assertions, in accordance with embodiments of the present disclosure.

In one embodiment, the example of the user interface shown in FIG. 2E can illustrate an “Equation Results Reasoning” tab of a detail view for a candidate assertion. In the example shown, the candidate assertion is a compound statement about current ratio and quick ratio values across multiple reporting periods, which has been decomposed into multiple candidate assertions (e.g., sub-components) as described with reference to FIG. 2C. The example of the user interface shown in FIG. 2E can be presented on a client device (e.g., the device 102A-102N of FIG. 1 and/or the device 402 of FIG. 4A) and/or can be generated by the system (e.g., the host server 300 via the interface and serving module 310).

The example of the user interface shown in FIG. 2E can display or depict equation outputs (e.g., numerical results of a sequence of analyses) and/or a breakdown of how those outputs contribute to an evaluation result and/or a verification status for each of the multiple candidate assertions (e.g., sub-components).

For each sub-component, the example of the user interface shown in FIG. 2E can display or depict intermediate evaluation results for multiple reporting periods. For example, for a first sub-component such as “The Current Ratio of Merck was 1.47,” the example of the user interface can display or depict results for each of FY2022, Q12023, Q22023, and/or Q32023. For each reporting period, the example of the user interface can display or depict:
An equation (e.g., “Current Ratio (FY2022)=Current Assets (FY2022)/Current Liabilities (FY2022)”);
A result (e.g., “2” for FY2022, “1.42 . . . ” for Q12023, “2” for Q22023, “1.5” for Q32023);
A verification indication (e.g., “The stated current ratio was 1.47, while the calculated result is 2” or “The stated current ratio was 1.47, while the calculated result is approximately 1.42”); and/or
A category indication (e.g., “Category: 2. The financial fact was originally incorrect, but with the equation result, the correct financial fact was found, and we are able to correct the financial fact”).

Similarly, for a second sub-component such as “The Quick Ratio of Merck was 0.93,” the example of the user interface shown in FIG. 2E can display or depict results for each reporting period. For each reporting period, the example of the user interface can display or depict an equation (e.g., “Quick Ratio (FY2022)=(Current Assets (FY2022)−Inventory (FY2022))/Current Liabilities (FY2022)”), a result (e.g., “0.527 . . . ” for FY2022), a verification indication (e.g., “The stated quick ratio was 0.93, while the calculated result is approximately 0.53”), and/or a category indication.

In one embodiment, the example of the user interface shown in FIG. 2E can display or depict how each computed result compares to a tolerance parameter or a tolerance threshold associated with the verification strategy. For example, if a stated value is 1.47 and a computed value is 2, the example of the user interface can indicate that the difference exceeds a tolerance threshold and/or that the candidate assertion is contradicted for that reporting period.

In a further embodiment, the intermediate evaluation results displayed in the example of FIG. 2E can correspond to evaluation results for candidate assertions that are logically related to one another. For example, the system can evaluate a first candidate assertion (e.g., about current ratio for FY2022) and/or can use the evaluation result of the first candidate assertion when evaluating another candidate assertion (e.g., about current ratio for Q12023) that is logically related to the first candidate assertion.

The example of the user interface shown in FIG. 2E can also display or depict component-level outcomes indicating whether each underlying equation or condition passed or failed. For example, the example of the user interface can indicate that retrieval of evidence data succeeded, that computation of a ratio succeeded, and/or that comparison to a stated value resulted in a match or a mismatch.

In some embodiments, the verification status for each intermediate evaluation result can be one of: supported, contradicted, not verifiable, or uncertain. The example of the user interface shown in FIG. 2E can display or depict graphical indicators (e.g., colored icons, badges, or labels) corresponding to the verification status for each reporting period and/or each sub-component.

By presenting the equation outputs, intermediate evaluation results, and/or component-level outcomes, the example of FIG. 2E can provide a transparent and granular view into how the system evaluates each portion of a compound candidate assertion. The intermediate evaluation results displayed in the example of FIG. 2E can be stored in, or derived from, the evaluation record for the candidate assertion.

In one embodiment, the example of the user interface shown in FIG. 2E can enable a user to interactively explore the equation results reasoning (e.g., by expanding, collapsing, or drilling down into individual reporting periods, sub-components, or intermediate results).

FIG. 2F depicts an example of a user interface showing a result of a fact-check including an evaluation result and/or a document-level evaluation result based on evaluation results for multiple candidate assertions, in accordance with embodiments of the present disclosure.

In one embodiment, the example of the user interface shown in FIG. 2F can illustrate a continuation of the “Equation Results Reasoning” tab, displaying a final conclusion section for a candidate assertion. The example of the user interface shown in FIG. 2F can be presented on a client device (e.g., the device 102A-102N of FIG. 1 and/or the device 402 of FIG. 4A) and/or can be generated by the system (e.g., the host server 300 via the assertion evaluation module 322 and/or the output and reporting module 325).

The example of the user interface shown in FIG. 2F can display or depict a summary of evaluation results for each sub-component of a compound candidate assertion. For example, for a first sub-component such as “Sub-component 1: Current Ratio,” the example of the user interface can display or depict an overall conclusion (e.g., “All results fall into category 2, indicating that the original financial fact was incorrect, but the correct financial fact was determined through the equation results”). Similarly, for a second sub-component such as “Sub-component 2: Quick Ratio,” the example of the user interface can display or depict an overall conclusion for that sub-component.

In a further embodiment, the example of the user interface shown in FIG. 2F can display or depict an overall evaluation result and/or a verification status for the entire candidate assertion (e.g., an “Entire FACT Conclusion”). For example, the example of the user interface can display or depict that “The entire FACT falls into category 2 because both sub-components were originally incorrect, but the correct financial facts were determined through the equation results.” The verification status for the entire candidate assertion can be one of: supported, contradicted, not verifiable, or uncertain.

In one embodiment, the example of the user interface shown in FIG. 2F can display or depict a confidence score that indicates a likelihood that the verification status is correct. The confidence score can be computed by the assertion evaluation module 322 based at least in part on source reliability, reasoning strength, and/or convergence of evidence data from multiple evidence sources.

In some embodiments, the example of the user interface shown in FIG. 2F can display or depict a document-level evaluation result for an electronic content item based at least in part on evaluation results for multiple candidate assertions in the electronic content item. The document evaluation module 324 can determine a verification metric for the electronic content item (e.g., counts or percentages of candidate assertions in each verification status) and/or can rank sections of the electronic content item based on the verification statuses of the multiple candidate assertions.

In a further embodiment, the example of the user interface shown in FIG. 2F can display or depict a suggested annotation or a modified version of the electronic content item (e.g., a rewritten sentence or corrected claim). For example, if a candidate assertion states “The current ratio was 1.47” and the system determines that the computed current ratio is 2, the output and reporting module 325 can generate suggested rewrite text such as “The current ratio was 2” or an annotation indicating that the stated value is contradicted by the evidence data that has been retrieved. The example of the user interface can present this suggestion so that the user can understand and, if desired, adopt the modified text.

In one embodiment, the example of the user interface shown in FIG. 2F can support user feedback. For example, the user can confirm or override the evaluation result via controls displayed in the example of FIG. 2F. The client device (e.g., the device 402) can transmit user feedback indicating a confirmation or an override of the evaluation result to the host server (e.g., the host server 300). A feedback and adaptation module (e.g., the feedback and adaptation module 308) can update the evaluation result in response to the confirmation or the override, can store user feedback associated with the evaluation result, and/or can use the user feedback to adjust one or more tolerance thresholds or tolerance parameters of the verification strategy for future evaluations.

In a further embodiment, tolerance thresholds or tolerance parameters can be configured based at least in part on a grounding reference frame (e.g., a named configuration such as “Regulator Strict” or “Internal Review”). The grounding reference frame can specify which evidence sources are preferred or excluded, confidence or preference rankings for evidence sources, and/or tolerance levels for different assertion types. The grounding reference frame can be configured on a global basis, on a per-organization basis, or on a per-user basis.

Thus, the example of FIG. 2F illustrates an embodiment in which the system can compute an evaluation result and/or a verification status for a candidate assertion based on equation outputs, can break down the result into interpretable components, can present a possible modified version of the electronic content item, and/or can incorporate user feedback to refine future verification behavior.

Advanced Verification Controls, Robustness, and Governance: In various embodiments, the system provides advanced verification controls that enhance robustness, auditability, scalability, and governance of automated verification of candidate assertions in electronic content items. These controls operate in concert with assertion extraction, verification strategy determination, evidence retrieval, normalization, evaluation, and reporting modules to ensure reliable operation in adversarial, high-volume, regulated, or high-stakes environments.

In one embodiment, the system is configured to detect and mitigate adversarial or manipulative candidate assertions designed to exploit automated verification processes. Such adversarial assertions can include selectively framed claims, cherry-picked statistics, misleading denominators or baselines, selectively chosen time windows, circular or self-referential citations, prompt-injection artifacts, or other techniques intended to distort factual interpretation or evade verification. In some embodiments, the assertion evaluation module (e.g., the assertion evaluation module 322) and/or conflict resolution module (e.g., the conflict resolution module 323) applies adversarial analysis techniques to identify statistical manipulation patterns, including p-hacking, omission of countervailing data, inconsistent reference periods, or reuse of non-independent evidence sources. Detection of such patterns can result in degradation of confidence scores, elevation of verification status to uncertain, exclusion or down-weighting of suspect evidence sources, or escalation to enhanced verification workflows.

In one embodiment, the system maintains verifiable provenance and lineage records for evidence data used to evaluate candidate assertions. Evidence snapshots can be associated with cryptographic hashes, timestamps, source identifiers, and retrieval metadata, enabling reconstruction of the precise verification context at a later time. In some embodiments, the system generates replayable verification trails that capture the sequence of evidence retrieval, normalization, reasoning steps, conflict resolution, and evaluation outcomes applied to a candidate assertion. These trails can be stored as evaluation records and optionally exported as machine-verifiable audit artifacts suitable for regulatory review, litigation, compliance reporting, or internal governance.

In one embodiment, verification strategies are selected based not only on assertion properties and accuracy requirements, but also on operational constraints including cost budgets, latency targets, and computational resource limits. The strategy determination module can perform multi-objective optimization to balance verification accuracy against cost, latency, energy consumption, or system load.

For example, the system may select a verification strategy based at least in part on a cost constraint associated with premium data sources, a latency threshold associated with real-time or batch processing, or a computational budget associated with available processing capacity. In some embodiments, lower-cost or lower-latency strategies are executed initially, with automatic escalation to more resource-intensive strategies when confidence thresholds are not satisfied.

In one embodiment, verification results are propagated across related electronic content items, document collections, or derivative assets. When a candidate assertion is verified, contradicted, or updated, the system can identify downstream documents, dashboards, presentations, or repositories that reference the same or similar assertions and update associated evaluation records. In some embodiments, contradicted or invalidated assertions trigger alerts, notifications, or remediation workflows across related assets. Versioning metadata is maintained to track when assertions were last verified, revised, or invalidated, enabling enterprise-wide consistency and preventing reintroduction of previously corrected misinformation.

In one embodiment, the system supports counterfactual or scenario-based verification in which candidate assertions are evaluated under alternate assumptions, definitions, or regulatory contexts. Such assumptions can include differing accounting standards, alternate inflation indices, jurisdiction-specific regulatory frameworks, or policy regimes. In some embodiments, the system produces multiple evaluation results for a single candidate assertion, including indicating that the assertion is supported under a first assumption set and contradicted under a second assumption set. These results can be presented alongside corresponding grounding reference frames to enable transparent interpretation of context-dependent validity.

In one embodiment, the system enforces explicit human-in-the-loop escalation policies based on confidence scores, assertion materiality, domain sensitivity, or regulatory impact. Candidate assertions with confidence scores below a threshold or with high potential impact can be automatically routed for human review. In some embodiments, escalation workflows capture reviewer identity, role, decision rationale, and override justification, and associate such information with evaluation records. Human feedback can be incorporated into future verification strategy selection, tolerance adjustment, and evidence source weighting.

Unlike systems that rely solely on single-model inference, static rule sets, or post-hoc citation retrieval, embodiments of the present disclosure dynamically orchestrate verification strategies, evidence normalization, multi-modal reasoning, confidence-aware evaluation, and governance controls to produce explainable, auditable, and context-aware verification outcomes. In various embodiments, the disclosed systems operate using large language models, symbolic reasoning engines, rule-based systems, statistical models, or any combination thereof. Certain embodiments operate without reliance on generative language models, instead employing deterministic logic, formal equations, or domain-specific rules.

For purposes of this disclosure, a candidate assertion refers to any factual claim identified within an electronic content item and subject to verification; a verification strategy refers to a configurable sequence of evidence selection, reasoning, normalization, and evaluation steps applied to a candidate assertion; and a grounding reference frame refers to a configurable context defining authoritative sources, tolerance thresholds, and interpretive assumptions.

Although the examples of FIGS. 2A-2F illustrate user interfaces for verifying candidate assertions in financial content (e.g., financial reports, analyst reports, or filings), the systems and methods described herein can be applied to verify candidate assertions in any type of electronic content item having natural-language text. For example, the system can be used to verify candidate assertions in one or more of: news articles, social media posts, scientific publications, legal documents, contracts, regulatory filings, educational materials, code repositories (e.g., assertions embedded in source code or code comments), multimedia content (e.g., assertions derived from images, video, or audio), and/or any other content containing factual claims. The verification strategies, evidence sources, assertion types, and/or tolerance thresholds can be adapted or configured for each application domain. For example, verifying candidate assertions in scientific publications can involve selecting evidence sources such as academic databases or peer-reviewed journals, while verifying candidate assertions in legal documents can involve selecting evidence sources such as case law databases or regulatory filings. The systems and methods disclosed herein are not limited to financial applications and can be extended to any domain in which automated fact verification is useful or desired.

FIG. 3A depicts an example functional block diagram of a host server 300 that facilitates verification of candidate assertions in electronic content items, in accordance with embodiments of the present disclosure.

The host server 300 includes a network interface 302, a verification engine 304, a knowledge base management module 306, a feedback and adaptation module 308, and/or an interface and serving module 310. The host server 300 is also coupled to a user repository 328, an evaluation record repository 330, and/or a knowledge base repository 332. The verification engine 304 further includes a content ingestion module 312, an assertion extraction module 314, a strategy determination module 316, an evidence source selection module 318, an evidence retrieval module 320, an evidence normalization module 321, an assertion evaluation module 322, a conflict resolution module 323, a document evaluation module 324, and/or an output and reporting module 325. Each of these modules can be coupled to each other.

Additional or less modules can be included without deviating from the techniques discussed in this disclosure. In addition, each module in the example of FIG. 3A can include any number and combination of sub-modules, and systems, implemented with any combination of hardware and/or software modules.

The host server 300, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

The network interface 302 can be a networking module that enables the host server 300 to mediate data in a network with an entity that is external to the host server 300, through any known and/or convenient communications protocol supported by the host and the external entity. The network interface 302 can include one or more of a network adapter card, a wireless network interface card (e.g., SMS interface, WiFi interface, interfaces for various generations of mobile communication standards including but not limited to 1G, 2G, 3G, 3.5G, 4G, LTE, 5G, etc.), Bluetooth, a router, an access point, a wireless router, a switch, a multilayer switch, a protocol converter, a gateway, a bridge, bridge router, a hub, a digital media receiver, and/or a repeater. Through the network interface 302, the host server 300 can receive electronic content items and feedback from client devices 102A-102N or the client device 402, can access external evidence sources such as regulatory filing systems (for example, EDGAR-style repositories), company databases, public data APIs, internal enterprise systems of record, document stores, news feeds, and other real-time streams, and can transmit evaluation results, annotated content, fact-check reports, and summary metrics back to client devices and other services.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 300 includes the verification engine 304. The verification engine 304 can be any combination of software agents and/or hardware modules (e.g., including processors and/or memory units) able to coordinate verification of candidate assertions in electronic content items. The verification engine 304 can orchestrate the operation of the content ingestion module 312, assertion extraction module 314, strategy determination module 316, evidence source selection module 318, evidence retrieval module 320, evidence normalization module 321, assertion evaluation module 322, conflict resolution module 323, document evaluation module 324, and/or output and reporting module 325. For example, when the host server 300 receives a quarterly financial report through the network interface 302, the verification engine 304 can trigger ingestion of the report, extraction of statements about revenue, margins, headcount, or guidance, selection of a dynamic verification strategy for each assertion, retrieval of financial time-series data from regulatory databases and market data feeds, normalization of fiscal calendars and currencies, evaluation of growth equations using a mathematical execution environment, and/or generation of a fact-check report that annotates the original document and summarizes discrepancies.

The verification engine 304 can also coordinate with external AI agents, research agents, and/or citation agents. For example, the verification engine 304 can invoke a research agent to locate additional sources when evidence is insufficient, and/or invoke a citation agent to validate and format citations for sources used in verification. The verification engine 304 can integrate outputs from such external agents as additional evidence data and/or reasoning traces. The verification engine 304 can invoke different artificial intelligence (AI) models, machine learning (ML) models, rule engines, and/or heuristic systems via an abstraction layer, and the models can be replaced, upgraded, or combined without affecting the overall verification pipeline.

One embodiment of the verification engine 304 includes the content ingestion module 312. The content ingestion module 312 can be any combination of software agents and/or hardware modules (e.g., including processors and/or memory units) able to receive and preprocess electronic content items from client devices or other services. In various embodiments, the content ingestion module 312 can accept heterogeneous formats, including free-form text documents, HTML or XBRL filings, PDF documents, spreadsheets, emails, chat logs, or messages received as part of a streaming pipeline. The content ingestion module 312 can normalize encodings, extract main content from navigation or boilerplate, and/or convert content into an internal representation suitable for downstream analysis. For example, the content ingestion module 312 can identify narrative sections and financial tables within an annual report, preserve table structure so that each row and cell can later be treated as a potential assertion, and attach metadata indicating the section, table identifier, or heading hierarchy from which each piece of content was extracted. In some embodiments, the content ingestion module 312 can also ingest configuration files or code snippets and mark code comments or embedded docstrings as potential sources of factual assertions, enabling code-level fact verification. The content ingestion module 312 can also receive multimedia content items including images, videos, and/or audio files, and can invoke optical character recognition (OCR), automatic speech recognition (ASR), and/or image analysis to extract textual representations from multimedia content.

One embodiment of the verification engine 304 further includes the assertion extraction module 314. The assertion extraction module 314 can be any combination of software agents and/or hardware modules (e.g., including processors and/or memory units) able to identify candidate assertions in an electronic content item. In some implementations, the assertion extraction module 314 can apply natural-language processing techniques such as sentence segmentation, dependency parsing, named-entity recognition, and/or pattern or template matching to detect factual statements that can be checked against external data. The assertion extraction module 314 can also implement compound fact decomposition, where a complex sentence containing multiple claims is broken into atomic candidate assertions. For instance, a sentence such as “Our revenue grew 20% to $10M and our EBITDA margin expanded by 300 basis points year-over-year” can be decomposed into separate assertions about revenue level, growth rate, and margin change. The assertion extraction module 314 can parse structured elements such as balance sheet tables or KPI tables, converting each cell into a candidate assertion that includes an entity, metric name, value, and reporting period. In further embodiments, the assertion extraction module 314 can identify assertions embedded in code or configuration files, such as comments describing performance characteristics or documented assumptions in model code. The assertion extraction module 314 can associate each candidate assertion with location metadata indicating where in the electronic content item the assertion appears, such as a section identifier, paragraph index, table coordinates, or character offsets, so that evaluation results can later be mapped back to the original context. The assertion extraction module 314 can also classify each candidate assertion into an assertion type including one or more of numeric, categorical, temporal, comparative, forward-looking, and/or opinion, and can assign a fact-versus-opinion label to distinguish factual assertions from opinion-based assertions.

One embodiment of the verification engine 304 further includes the strategy determination module 316. The strategy determination module 316 can be any combination of software agents and/or hardware modules (e.g., including processors and/or memory units) able to determine a verification strategy for each candidate assertion based at least in part on one or more properties of the candidate assertion. In various embodiments, the strategy determination module 316 can classify a candidate assertion into an assertion type such as numeric, categorical, temporal, composite, or code-derived, and can select or construct a dynamic verification strategy appropriate for that type. For example, a numeric growth assertion may be assigned a strategy that requires equation generation and solving, such as computing the percentage change between two financial periods using historical values retrieved from filings. A categorical assertion about a company's industry classification or headquarters location may be assigned a strategy that compares normalized category labels across multiple data providers and knowledge graphs. A temporal assertion about an executive's tenure may be assigned a strategy that checks start dates and role history across corporate registries and internal HR systems. In some implementations, the strategy determination module 316 can invoke a machine-learning model that receives features derived from the candidate assertion (for example, linguistic patterns, referenced entities, domain tags, and prior outcomes for similar assertions) and outputs a predicted verification strategy or parameter configuration. The strategy determination module 316 can select tolerance parameters and thresholds based on the assertion type and on one or more policies, such as stricter thresholds for financial statements in audited filings versus more relaxed thresholds for informal commentary. The strategy determination module 316 can also consult adjustable grounding reference frames that define which data sources are authoritative, how strict tolerance thresholds should be, and/or a verification perspective (e.g., regulatory, marketing, internal draft, investor disclosure), and can consult personalized fact-checking profiles stored in the user repository 328. For forward-looking or predictive assertion types, the strategy determination module 316 can select verification strategies that fetch historical data, invoke or query a predictive model, and/or compare the asserted forecast to model outputs and confidence intervals. For opinion-type assertions, the strategy determination module 316 can select strategies that verify the source of the opinion, check whether quoted text matches original statements, and/or retrieve corroborating or dissenting context. The strategy determination module 316 can also route logical or mathematical assertions to a theorem-proving engine or symbolic reasoning system.

One embodiment of the verification engine 304 further includes the evidence source selection module 318. The evidence source selection module 318 can be any combination of software agents and/or hardware modules (e.g., including processors and/or memory units) able to select one or more evidence sources for evaluating a candidate assertion. In some embodiments, the evidence source selection module 318 can resolve an entity referenced in a candidate assertion to a canonical entity identifier stored in the knowledge base repository 332 and can use that identifier to decide which sources to query. For a public company, the evidence source selection module 318 can select one or more regulatory filing repositories as primary sources, along with market data providers, internal data warehouses, and curated knowledge graphs as secondary sources. For a claim about code behavior or configuration, the evidence source selection module 318 can select a source code repository, configuration database, or continuous-integration logs. The evidence source selection module 318 can generate one or more query templates based at least in part on the verification strategy determined by the strategy determination module 316 and can specify which fields, time periods, and filters to use when retrieving evidence for the candidate assertion. In some implementations, the evidence source selection module 318 can also consider real-time evidence streams, such as news feeds or market tick data, to support proactive or predictive fact-checking. The evidence source selection module 318 can also select from sensor networks, telemetry feeds, and/or IoT platforms as evidence sources for assertions involving time-bound physical conditions, and can invoke external research agents and/or citation agents as specialized evidence sources when sources are not explicitly cited or are incomplete.

One embodiment of the verification engine 304 further includes the evidence retrieval module 320. The evidence retrieval module 320 can be any combination of software agents and/or hardware modules (e.g., including processors and/or memory units) able to issue queries to selected evidence sources and aggregate returned evidence data. In various embodiments, the evidence retrieval module 320 can rank available data sources based on one or more factors such as reliability, recency, domain coverage, or cost, and can prioritize higher-ranked sources when constructing a retrieval plan. The evidence retrieval module 320 can issue queries in parallel to multiple APIs, databases, document repositories, or web endpoints and/or merge the results into an internal representation. For example, to verify a claim that “Total assets exceeded $500 million as of Dec. 31, 2023,” the evidence retrieval module 320 can retrieve the latest audited balance sheet from a regulatory filing system, cross-check against a structured market data feed, and consult an internal data warehouse if access is available. The evidence retrieval module 320 can apply different access methods, including authenticated API calls, database queries, and, where allowed, web scraping to extract values from unstructured or semi-structured sources. When a primary source does not return data satisfying a completeness criterion or is temporarily unavailable, the evidence retrieval module 320 can query alternate sources or use cached evidence from the knowledge base repository 332.

One embodiment of the verification engine 304 further includes the evidence normalization module 321. The evidence normalization module 321 can be any combination of software agents and/or hardware modules (e.g., including processors and/or memory units) able to normalize heterogeneous evidence data to a canonical representation suitable for comparison with a candidate assertion. In some embodiments, the evidence normalization module 321 can perform fiscal calendar normalization by aligning financial metrics reported according to different fiscal year-ends into a common comparison period. For instance, if one company's fiscal year ends in March and another's in December, the evidence normalization module 321 can adjust time periods so that year-over-year or peer comparisons are computed over comparable windows. The evidence normalization module 321 can convert values between currencies and units, apply historical exchange rates, and/or compute derived metrics such as growth rates, margins, and ratios specified by the verification strategy. The evidence normalization module 321 can also map differing textual labels (for example, differing industry descriptors across data vendors) into a shared taxonomy so that categorical assertions can be compared consistently. In some implementations, the evidence normalization module 321 can also prepare normalized, machine-readable representations of evidence that can be reused across assertions and stored in the knowledge base repository 332.

One embodiment of the verification engine 304 further includes the assertion evaluation module 322. The assertion evaluation module 322 can be any combination of software agents and/or hardware modules (e.g., including processors and/or memory units) able to evaluate a candidate assertion based at least in part on normalized evidence data and the associated verification strategy. In various implementations, the assertion evaluation module 322 can determine a verification status for the candidate assertion, such as supported, contradicted, not verifiable, or uncertain, and can compute a confidence score indicating a likelihood that the verification status is correct. For numeric financial claims, the assertion evaluation module 322 can recompute metrics (such as growth, ratios, or compound changes) using normalized values and compare them to the claimed values using tolerance thresholds derived from assertion type and policy.

For categorical claims, the assertion evaluation module 322 can compare normalized labels across evidence sources and detect mismatches or partial matches. For temporal claims and predictive statements, the assertion evaluation module 322 can check whether the asserted time intervals align with evidence and can, in predictive contexts, track whether predicted events materialize over time. In some embodiments, the assertion evaluation module 322 can combine multiple reasoning methods, such as direct data comparison, code-generated equation solving, heuristics, and AI-driven logical analysis, to arrive at a verification status and can encode its reasoning path in metadata attached to the evaluation result. The assertion evaluation module 322 can also perform methodology checking to verify how a value was computed, not just its numeric equality, and can apply fuzzy logic and/or probabilistic methods to represent gradations of truth for assertions where discrete true/false labels are inadequate. For complex assertions, the assertion evaluation module 322 can invoke or construct financial models for multi-step projections, scenario analysis, and/or sensitivity analysis. The assertion evaluation module 322 can also evaluate another candidate assertion using the evaluation result of a candidate assertion that is logically related to the other candidate assertion.

One embodiment of the verification engine 304 further includes the conflict resolution module 323. The conflict resolution module 323 can be any combination of software agents and/or hardware modules (e.g., including processors and/or memory units) able to resolve conflicts between evidence data obtained from different sources. In some embodiments, the conflict resolution module 323 can assign weights or reliability scores to evidence items based on source type (for example, audited regulatory filing versus informal blog post), historical accuracy, recency, or user-defined trust policies stored in the user repository 328. The conflict resolution module 323 can then combine or select among conflicting values based on these weights. For example, when revenue values for the same period differ slightly across data providers, the conflict resolution module 323 can favor audited filings and treat other values as informative but lower priority. In more severe conflict cases, such as a mismatch between an internal system of record and a public filing, the conflict resolution module 323 can flag the assertion as uncertain, attach a description of the conflict, and/or record this state in the knowledge base repository 332 so that human reviewers or external research agents can investigate.

One embodiment of the verification engine 304 further includes the document evaluation module 324. The document evaluation module 324 can be any combination of software agents and/or hardware modules (e.g., including processors and/or memory units) able to aggregate evaluation results across multiple candidate assertions associated with a given electronic content item. In various embodiments, the document evaluation module 324 can compute one or more verification metrics for an electronic content item based on the verification statuses and confidence scores of multiple candidate assertions. Examples include a proportion of supported assertions, a weighted reliability index that gives more weight to high-impact or high-value assertions, or separate metrics for historical facts versus projections. The document evaluation module 324 can rank sections or paragraphs based on the density of contradicted or uncertain assertions, enabling the system to identify “hot spots” in a document where the factual foundation is weak. In the context of an investment memo, for example, the document evaluation module 324 can compute separate metrics for the historical performance section, the forecast section, and the risk disclosures, and can signal to a user which parts rely most heavily on unsupported assumptions. The document evaluation module 324 can also perform consistency checking across related assertions in a single document or collection of documents, checking for conflicting assertions about the same entity, period, or metric, and can support both static and dynamic fact-checking modes where dynamic assertions are periodically re-verified when underlying data changes.

One embodiment of the verification engine 304 further includes the output and reporting module 325. The output and reporting module 325 can be any combination of software agents and/or hardware modules (e.g., including processors and/or memory units) able to generate outputs that describe how candidate assertions have been evaluated and to prepare those outputs for consumption by client devices and other systems. In some implementations, the output and reporting module 325 can generate evaluation records that include, for each candidate assertion, the verification status, confidence score, identifiers of evidence data and sources used, and/or any conflict resolution details. The output and reporting module 325 can generate an output that combines the original electronic content item with display data corresponding to these evaluation records, such as markup, overlays, or structured metadata that a client device can use to render visual indicators and interactive elements. For example, the output and reporting module 325 can generate a fact-check report that includes an annotated version of the original filing, a table summarizing all evaluated assertions and their statuses, and/or optional visualizations such as charts of recomputed financial metrics based on normalized evidence. Client devices 102A-102N or 402 can use these outputs to support interactive fact-checking, where users explore evidence, drill into specific assertions, and/or request alternate views or scenarios. The output and reporting module 325 can also generate a modified version of the electronic content item in which text associated with a candidate assertion is annotated or rewritten if the evaluation result indicates contradiction or uncertainty.

One embodiment of the host server 300 further includes the knowledge base management module 306. The knowledge base management module 306 can be any combination of software agents and/or hardware modules (e.g., including processors and/or memory units) able to manage information stored in the knowledge base repository 332. In various embodiments, the knowledge base repository 332 can store canonical entity identifiers, mappings between textual names and identifiers, cached evidence data, historical evaluation records, candidate assertion signatures, and/or knowledge graphs capturing relationships between entities, metrics, and assertions. The knowledge base management module 306 can compute candidate assertion signatures that capture essential aspects of a candidate assertion and its context, such as entity, metric, period, and formula structure. When a new candidate assertion has a signature that matches a stored signature, the knowledge base management module 306 can retrieve a prior evaluation result and associated evidence identifiers and supply them to the assertion evaluation module 322, reducing repeated retrieval and recomputation. The knowledge base management module 306 can also support “saved knowledge base of previously checked factual statements” behavior where prior fact-checks can be surfaced as additional evidence or explanations for new verifications that touch related topics. The knowledge base repository 332 can have permissions on data records such that they can be used to verify facts for authorized users, supporting different fact-bases for different users or organizations.

One embodiment of the host server 300 further includes the feedback and adaptation module 308. The feedback and adaptation module 308 can be any combination of software agents and/or hardware modules (e.g., including processors and/or memory units) able to receive and process feedback related to evaluation results and to adapt system behavior over time. For example, a client device 402 can present evaluation results to a human analyst, who may confirm or override specific verification statuses, attach comments, or label certain evidence sources as unreliable or very reliable. The feedback and adaptation module 308 can store such feedback in association with evaluation records and/or update parameters used by the strategy determination module 316, evidence source selection module 318, and/or assertion evaluation module 322. In some embodiments, the feedback and adaptation module 308 can adjust tolerance thresholds, promote or demote sources in the ranking maintained by the evidence retrieval module 320, or trigger retraining of a machine-learning model used for strategy prediction. The feedback and adaptation module 308 can also integrate with other AI agents, such as a citation agent that locates primary sources, or a research assistant agent that conducts deeper investigations in online and offline repositories when automated verification yields low-confidence or unresolved outcomes. Findings from such external agents can be incorporated into the knowledge base repository 332 and used to improve future verifications. The feedback and adaptation module 308 can also aggregate feedback from multiple users contributing to the same evaluation record, compute aggregation metrics (e.g., counts, confidence adjustments, consensus metrics), and/or update policies, thresholds, or source rankings to reflect collective judgments.

One embodiment of the host server 300 further includes the interface and serving module 310. The interface and serving module 310 can be any combination of software agents and/or hardware modules (e.g., including processors and/or memory units) able to provide programmatic access to the verification engine 304 and related components of the host server 300. In various implementations, the interface and serving module 310 can expose one or more APIs through which client devices 102A-102N or 402 submit content for verification, retrieve evaluation results, and/or manage verification policies. This enables a “fact-checking as a service” model in which external applications integrate automated verification into their workflows. The interface and serving module 310 can support synchronous request-response interactions for smaller documents, asynchronous processing for large batches, and/or streaming interfaces for proactive or real-time fact-checking of live feeds. For example, the interface and serving module 310 can subscribe to a news feed or social media stream, pass relevant posts through the content ingestion and assertion extraction pipeline, and/or push verification alerts to subscribed client systems when high-impact claims are contradicted by authoritative data.

The user repository 328 can store information associated with users, organizations, or tenants, including authentication data, role information, and/or verification policies. In some embodiments, the user repository 328 can support personalized fact-checking profiles that capture user- or tenant-specific preferences such as which domains to emphasize, which evidence sources to treat as authoritative, and how strict tolerance thresholds should be for different assertion types. These profiles can influence the behavior of the strategy determination module 316, evidence source selection module 318, assertion evaluation module 322, and/or document evaluation module 324. For example, one organization may configure tighter tolerances and a narrower set of “trusted” sources for regulatory filings, while another organization may allow looser tolerances or additional alternative data sources when exploring early-stage signals. The user repository 328 can also store grounding reference frames on a per-organization, per-user, and/or per-document basis.

The knowledge base repository 332 can store structured knowledge used by the knowledge base management module 306 and other components of the host server 300. The knowledge base repository 332 can include canonical entity identifiers, mappings between names and identifiers, cached evidence values, historical evaluation records, derived relationships between entities and assertions, and/or higher-level reasoning artifacts such as inferred trends or risk indicators. In some implementations, the knowledge base repository 332 can maintain graph structures and indices that enable the system to detect repeated misstatements, to suggest additional checks when certain assertion patterns appear, and/or to support advanced reasoning over sets of related content items.

FIG. 3B depicts an example block diagram illustrating the components of the host server 300 that facilitates verification of candidate assertions in electronic content items, in accordance with embodiments of the present disclosure.

In one embodiment, host server 300 includes a network interface 302, a processing unit 334, a memory unit 336, a storage unit 338, a location sensor 340, and/or a timing module 342. Additional or less units or modules may be included. The host server 300 can be any combination of hardware components and/or software agents to facilitate verification of candidate assertions in electronic content items. The network interface 302 has been described in the example of FIG. 3A.

One embodiment of the host server 300 includes a processing unit 334. The processing unit 334 can be any combination of hardware components able to execute instructions for verifying candidate assertions. Data received from the network interface 302, location sensor 340, and/or the timing module 342 can be input to the processing unit 334. The location sensor 340 can include GPS receivers, RF transceivers, optical rangefinders, and/or other positioning systems. The timing module 342 can include an internal clock, a connection to a time server (via NTP), an atomic clock, and/or a GPS master clock.

The processing unit 334 can include one or more processors, CPUs, microcontrollers, FPGAs, ASICs, DSPs, GPUs, or any combination of the above. Data that is input to the host server 300 can be processed by the processing unit 334 and output to a display and/or output via a wired or wireless connection to an external device, such as a client device 102A-N or client device 402, a host or server computer, or other computing systems via the network interface 302.

One embodiment of the host server 300 includes a memory unit 336 and a storage unit 338. The memory unit 336 and the storage unit 338 are, in some embodiments, coupled to the processing unit 334. The memory unit 336 can include volatile and/or non-volatile memory. In verification operations, the processing unit 334 can perform one or more processes related to verifying candidate assertions, including content ingestion, assertion extraction, strategy determination, evidence retrieval, evidence normalization, assertion evaluation, conflict resolution, document evaluation, and/or output generation as described with reference to FIG. 3A.

In some embodiments, any portion of or all of the functions described of the various example modules in the host server 300 of the example of FIG. 3A can be performed by the processing unit 334. For example, the processing unit 334 can execute instructions stored in the memory unit 336 and/or storage unit 338 that implement the verification engine 304, the content ingestion module 312, the assertion extraction module 314, the strategy determination module 316, the evidence source selection module 318, the evidence retrieval module 320, the evidence normalization module 321, the assertion evaluation module 322, the conflict resolution module 323, the document evaluation module 324, the output and reporting module 325, the knowledge base management module 306, the feedback and adaptation module 308, and/or the interface and serving module 310.

The storage unit 338 can store electronic content items received for verification, evidence data retrieved from evidence sources, evaluation records, knowledge base data including canonical entity identifiers and cached evidence, user profiles and verification policies, and/or machine-learning models used for strategy prediction and assertion classification. The memory unit 336 can provide working memory for active verification processes, including intermediate representations of candidate assertions, normalized evidence data, and in-progress evaluation results.

FIG. 4A depicts an example functional block diagram of a client device 402 having capabilities to facilitate verification of candidate assertions in electronic content items, in accordance with embodiments of the present disclosure.

The client device 402 includes a network interface 404, a timing module 406, an RF sensor 407, a location sensor 408, an image sensor 409, an assertion selection module 414, an evaluation presentation module 412, a user stimulus sensor 416, a motion/gesture sensor 418, a feedback capture module 420, an audio/video output module 422, and/or other sensors 410. The client device 402 can be any electronic device such as the devices described in conjunction with the client devices 102A-N in the example of FIG. 1 including but not limited to portable devices, a computer, a server, location-aware devices, mobile phones, PDAs, laptops, palmtops, iPhones, headsets, heads-up displays, helmet mounted displays, head-mounted displays, scanned-beam displays, smart lenses, monocles, smart glasses/goggles, wearable computers such as mobile enabled watches or eyewear, and/or any other mobile interfaces and viewing devices.

The client device 402 is also coupled to an evaluation record repository 431. The evaluation record repository 431 can store evaluation records, verification statuses, confidence scores, evidence identifiers, and/or cached results received from the host server 300 or generated locally by the client device 402.

Additional or less modules can be included without deviating from the novel art of this disclosure. In addition, each module in the example of FIG. 4A can include any number and combination of sub-modules, and systems, implemented with any combination of hardware and/or software modules.

The client device 402, although illustrated as comprised of distributed components (physically distributed and/or functionally distributed), could be implemented as a collective element. In some embodiments, some or all of the modules, and/or the functions represented by each of the modules can be combined in any convenient or known manner. Furthermore, the functions represented by the modules can be implemented individually or in any combination thereof, partially or wholly, in hardware, software, or a combination of hardware and software.

In the example of FIG. 4A, the network interface 404 can be a networking module that enables the client device 402 to mediate data in a network with an entity that is external to the client device 402, through any known and/or convenient communications protocol supported by the client device 402 and the external entity. The network interface 404 can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The client device 402 can provide functionalities described herein via a consumer client application (app). The consumer application includes a user interface that enables presentation of evaluation results for candidate assertions, interactive exploration of evidence data, and/or capture of user feedback.

One embodiment of the client device 402 includes the assertion selection module 414. The assertion selection module 414 can be any combination of software agents and/or hardware modules (e.g., including processors and/or memory units) able to enable a user to select one or more candidate assertions from an electronic content item for detailed review. In some embodiments, the assertion selection module 414 can present a list or visual representation of candidate assertions identified in an electronic content item, can highlight assertions based on verification status (e.g., supported, contradicted, uncertain, not verifiable), and/or can enable filtering or sorting of assertions by type, confidence score, or location in the document. The assertion selection module 414 can also enable a user to select a specific assertion to view associated evidence data, reasoning traces, and/or evaluation details.

One embodiment of the client device 402 further includes the evaluation presentation module 412. The evaluation presentation module 412 can be any combination of software agents and/or hardware modules (e.g., including processors and/or memory units) able to present evaluation results for candidate assertions to a user. In various embodiments, the evaluation presentation module 412 can render visual indicators of verification status (e.g., icons, color coding, or badges) overlaid on or adjacent to candidate assertions in the electronic content item. The evaluation presentation module 412 can also overlay markup, highlights, or annotations on text associated with candidate assertions to indicate verification status, and can render suggested rewrites or corrections for assertions that have been contradicted, enabling a user to view both the original text and a modified version reflecting verified evidence. The evaluation presentation module 412 can also present detailed evaluation information including the verification status, confidence score, identifiers of evidence sources used, normalized evidence values, equations or calculations performed, and/or conflict resolution details. For example, the evaluation presentation module 412 can display a chart showing financial metrics across multiple periods as retrieved from regulatory filings, enabling a user to compare claimed values against verified evidence. The evaluation presentation module 412 can also present interactive elements that enable a user to expand or collapse evidence details, switch between different reasoning views (e.g., data view, EDGAR data reasoning view, equation reasoning view, equation results reasoning view), navigate to source documents, and/or support multiple annotation modes such as inline annotations, margin notes, and/or pop-up tooltips.

One embodiment of the client device 402 further includes the feedback capture module 420. The feedback capture module 420 can be any combination of software agents and/or hardware modules (e.g., including processors and/or memory units) able to capture user feedback related to evaluation results. In various embodiments, the feedback capture module 420 can enable a user to confirm or override a verification status for a candidate assertion, to indicate that an evidence source is unreliable or particularly trustworthy, and/or to attach comments or notes to an evaluation record. The feedback capture module 420 can transmit captured feedback to the host server 300 via the network interface 404, where the feedback and adaptation module 308 can process the feedback to adjust tolerance thresholds, source rankings, and/or other verification parameters. The feedback capture module 420 can also store feedback locally in the evaluation record repository 431 for offline access.

One embodiment of the client device 402 further includes the image sensor 409. The image sensor 409 can be any combination of hardware components able to capture images or video of physical documents, screens, or other visual content. In some embodiments, the image sensor 409 can capture an image of a printed document, and the client device 402 can transmit the captured image to the host server 300 for content ingestion and assertion extraction. The image sensor 409 can also capture images of charts, tables, or other visual elements for verification against underlying data.

One embodiment of the client device 402 further includes the user stimulus sensor 416 and the motion/gesture sensor 418. The user stimulus sensor 416 can be any combination of hardware components able to detect user input such as touch, voice, or eye movement. The motion/gesture sensor 418 can be any combination of hardware components able to detect motion or gestures performed by a user. In various embodiments, the user stimulus sensor 416 and/or the motion/gesture sensor 418 can enable a user to interact with evaluation results through touch gestures (e.g., tap to select an assertion, swipe to navigate between assertions), voice commands (e.g., “show evidence for this claim”), and/or motion gestures (e.g., pointing at a specific assertion in an augmented reality display).

One embodiment of the client device 402 further includes the audio/video output module 422. The audio/video output module 422 can be any combination of hardware components able to present audio and/or video output to a user. In some embodiments, the audio/video output module 422 can render evaluation results on a display, can provide audio alerts when high-priority assertions are contradicted, and/or can present narrated explanations of verification reasoning.

FIG. 4B depicts an example block diagram of a client device having capabilities to facilitate verification of candidate assertions in electronic content items, in accordance with embodiments of the present disclosure.

In one embodiment, client device 402 includes a network interface 432, a processing unit 434, a memory unit 436, a storage unit 438, a location sensor 440, an accelerometer/motion sensor 442, a timer 444, an audio output unit/speakers 446, a display unit 450, an image capture unit 452, a pointing device/sensor 454, an input device 456, and/or a touch screen sensor 458. Additional or less units or modules may be included. The client device 402 can be any combination of hardware components and/or software agents for facilitating verification of candidate assertions in electronic content items. The network interface 432 has been described in the example of FIG. 4A.

One embodiment of the client device 402 includes a processing unit 434. The processing unit 434 can be any combination of hardware components able to execute instructions for presenting evaluation results and capturing user feedback related to candidate assertion verification.

The processing unit 434 can include one or more processors, CPUs, microcontrollers, FPGAs, ASICs, DSPs, GPUs, or any combination of the above. Data that is input to the client device 402, for example, via the image capture unit 452, pointing device/sensor 454, input device 456 (e.g., keyboard), and/or the touch screen sensor 458 can be processed by the processing unit 434 and output to the display unit 450, audio output unit/speakers 446 and/or output via a wired or wireless connection to an external device, such as a host or server computer such as the host server 300 by way of the network interface 432.

One embodiment of the client device 402 further includes a memory unit 436 and a storage unit 438. The memory unit 436 and the storage unit 438 are, in some embodiments, coupled to the processing unit 434. The memory unit 436 can include volatile and/or non-volatile memory. The processing unit 434 can perform one or more processes related to facilitating verification of candidate assertions in electronic content items, including presenting evaluation results, rendering visual indicators of verification status, capturing user feedback, and/or transmitting feedback to the host server 300.

In some embodiments, any portion of or all of the functions described of the various example modules in the client device 402 of the example of FIG. 4A can be performed by the processing unit 434. For example, the processing unit 434 can execute instructions stored in the memory unit 436 and/or storage unit 438 that implement the assertion selection module 414, the evaluation presentation module 412, and/or the feedback capture module 420.

The storage unit 438 can store evaluation records received from the host server 300, cached evidence data, user preferences and feedback history, and/or electronic content items being reviewed. The memory unit 436 can provide working memory for active presentation processes, including rendering of evaluation results, visual indicators, and/or interactive elements.

One embodiment of the client device 402 further includes the display unit 450. The display unit 450 can be any combination of hardware components able to render visual output to a user. In various embodiments, the display unit 450 can present electronic content items with overlaid evaluation results, visual indicators of verification status, charts showing evidence data, and/or interactive elements for exploring evaluation details. The display unit 450 can include LCD, LED, OLED, or other display technologies.

One embodiment of the client device 402 further includes the image capture unit 452. The image capture unit 452 can be any combination of hardware components able to capture images or video. In some embodiments, the image capture unit 452 can capture images of printed documents for transmission to the host server 300 for content ingestion and assertion extraction.

One embodiment of the client device 402 further includes the touch screen sensor 458, the pointing device/sensor 454, and/or the input device 456. The touch screen sensor 458 can be any combination of hardware components able to detect touch input on a display surface. The pointing device/sensor 454 can be any combination of hardware components able to detect pointing or selection input. The input device 456 can be any combination of hardware components able to receive alphanumeric or command input. In various embodiments, the touch screen sensor 458, pointing device/sensor 454, and/or input device 456 can enable a user to select candidate assertions for review, navigate between evaluation results, provide feedback on verification statuses, and/or enter comments or notes associated with evaluation records.

One embodiment of the client device 402 further includes the location sensor 440, the accelerometer/motion sensor 442, and/or the timer 444. The location sensor 440 can be any combination of hardware components able to determine geographic position. The accelerometer/motion sensor 442 can be any combination of hardware components able to detect motion or orientation. The timer 444 can be any combination of hardware components able to provide timing information. In some embodiments, the location sensor 440 can provide location context for evaluation results, the accelerometer/motion sensor 442 can enable gesture-based interaction with evaluation presentations, and/or the timer 444 can track time-based aspects of verification processes.

FIG. 5 depicts a flow chart illustrating an example process for verifying a candidate assertion in an electronic content item, in accordance with embodiments of the present disclosure.

In process 510, an electronic content item having natural-language text is received (e.g., by the content ingestion module 312 of the verification engine 304 of the host server 300 shown in the example of FIG. 3A). The electronic content item can include, for example, one or more of a financial report, a research document, a news article, a regulatory filing, a due diligence memorandum, an analyst report, an earnings call transcript, a press release, a prospectus, an investment thesis, or any other document containing factual assertions to be verified. The electronic content item can also include, for example, legal contracts, regulatory submissions, clinical trial summaries, scientific articles, educational materials, government policy briefs, social media posts, user-generated content, or content flagged by platform integrity systems for verification.

In one embodiment, the electronic content item may be a single sentence or a full document. The electronic content item may be received via an application programming interface, uploaded through a user interface, or ingested from a document management system. For example, as illustrated in FIG. 2A, a user may submit a financial analysis report for verification through a project interface, where the system can process the entire document to identify candidate assertions for verification. The electronic content item may also be received as part of a stream or batch of electronic content items for bulk processing.

In process 512, one or more candidate assertions in the electronic content item are identified (e.g., by the assertion extraction module 314 of the verification engine 304 shown in FIG. 3A). A candidate assertion is a factual statement or claim within the electronic content item that can be evaluated for accuracy against external evidence. The candidate assertion may include, for example, numeric assertions, categorical assertions, temporal assertions, comparative assertions, or compound assertions combining multiple factual elements.

For example, a candidate assertion can include a financial statement such as “the current ratio was 1.47, and the quick ratio was 0.93, indicating adequate liquidity to cover short-term obligations,” as illustrated in the fact-check reasoning view of the example of FIG. 2B. As another example, a candidate assertion may state that “revenue increased by 15% year-over-year” or “net income for Q3 2023 was $2.4 billion.” As a further example, a candidate assertion may involve a comparison between entities, such as “Company A's gross margin exceeded Company B's gross margin by 5 percentage points in fiscal year 2023.” In another example, a candidate assertion may involve a temporal claim, such as “the company achieved profitability for three consecutive quarters.”

In one embodiment, the candidate assertion is identified using natural-language processing including one or more of dependency parsing, named-entity recognition, or pattern-based detection. The system may parse structured content such as tables, source code, log entries, or markup to identify candidate assertions embedded within structured formats. The system may also decompose compound assertions into multiple atomic candidate assertions that can be individually verified. For example, the compound assertion “the current ratio was 1.47, and the quick ratio was 0.93” may be decomposed into two atomic assertions: one regarding the current ratio and one regarding the quick ratio, as illustrated in the example of FIG. 2D. This decomposition enables granular verification, allowing the system to pinpoint specific inaccuracies within complex claims and provide a more nuanced understanding of overall veracity. In one embodiment, the system may filter candidate assertions based on a parsing confidence score or an assertion type to prioritize assertions most suitable for automated verification.

In process 514, an evidence source is selected based on the verification strategy (e.g., by the evidence source selection module 318 of the verification engine 304 shown in the example of FIG. 3A). The verification strategy is determined based at least in part on one or more properties of the candidate assertion, including an assertion type. The assertion type may include one or more of numeric, categorical, and temporal. For a numeric assertion involving financial metrics, for example, the verification strategy may specify mathematical verification using equation generation and solving. For a categorical assertion, the verification strategy may specify data lookup and comparison against authoritative sources. For a temporal assertion, the verification strategy may specify timeline analysis and event sequencing verification.

For example, for a financial candidate assertion involving a publicly traded company, the evidence source can include SEC EDGAR financial filings such as 10-K annual reports, 10-Q quarterly reports, or 8-K current reports. As illustrated in the example of FIG. 2C, the system identifies the required evidence sources, such as quarterly or annual financial filings that include balance sheet data to calculate the current and quick ratios. In another example, for a candidate assertion regarding macroeconomic data, the evidence source may include government statistical databases, central bank publications, or international organization reports. For a candidate assertion regarding scientific claims, the evidence source may include peer-reviewed journals, academic databases, or authoritative scientific institutions. For a candidate assertion regarding product specifications, the evidence source may include manufacturer documentation, industry standards organizations, or certification bodies.

In one embodiment, multiple evidence sources are ranked based on one or more of source reliability, recency, or domain coverage, and the evidence sources are selected based on the ranking. A higher-ranked evidence source may be preferred when multiple sources provide conflicting information. In another embodiment, the system may resolve an entity referenced in the candidate assertion to a canonical entity identifier before selecting evidence sources. For example, the system may resolve company names, ticker symbols, or alternate identifiers to a canonical entity identifier to ensure accurate evidence retrieval. The system may generate query requests to the evidence sources based on the verification strategy and/or the one or more properties of the candidate assertion.

In process 516, evidence data is retrieved from the evidence source (e.g., by the evidence retrieval module 320 of the verification engine 304 shown in FIG. 3A). In one embodiment, query requests are issued in parallel to multiple evidence sources, and the evidence data received from the multiple evidence sources is aggregated. This parallel retrieval can improve verification latency for time-sensitive applications. In another embodiment, a fallback evidence source is selected when a primary evidence source fails to return evidence data that satisfies a completeness criterion. For example, if a company's quarterly filing is not yet available, the system may fall back to the most recent annual filing or to analyst estimates.

As illustrated in the example of FIG. 2C, the system retrieves financial filings for the fiscal year-end and quarterly filings that include balance sheet data required to verify the candidate assertion. For example, to verify an assertion regarding the current ratio, the system may retrieve values for current assets and current liabilities from the company's balance sheet. As another example, to verify an assertion regarding revenue growth, the system may retrieve revenue figures for multiple reporting periods to calculate the percentage change. The system may also retrieve data from multiple fiscal periods to enable trend analysis or multi-period comparisons. In one embodiment, the system handles the complexity of different fiscal year-ends by normalizing financial time periods across companies, automatically determining each entity's fiscal year start date and adjusting financial report dates accordingly to ensure accurate comparisons and calculations.

In process 518, the candidate assertion is evaluated based on the evidence data and/or the verification strategy (e.g., by the assertion evaluation module 322 of the verification engine 304 shown in FIG. 3A).

In one embodiment, the evidence data is normalized to a canonical representation prior to evaluation (e.g., by the normalization module 321 shown in the example of FIG. 3A). The normalizing can include one or more of converting numeric values expressed in different units or currencies into a common unit or currency (for example, converting values reported in millions to values reported in thousands, or converting foreign currency amounts to a common currency using applicable exchange rates), aligning financial metrics from different financial reporting periods into a common comparison period (for example, adjusting for companies with different fiscal year-ends or normalizing quarterly data to annual equivalents), and mapping different textual category labels into a shared taxonomy (for example, mapping industry-specific terminology to a standardized classification scheme).

As illustrated in the example of FIG. 2D, the system identifies equations needed to verify the candidate assertion, such as Current Ratio=Current Assets/Current Liabilities and Quick Ratio=(Current Assets-Inventory)/Current Liabilities, and retrieves the required values from the evidence data. For each fiscal period referenced in the candidate assertion (for example, FY2022, Q1 2023, Q2 2023, Q3 2023), the system can finalize the equation with real numbers pulled from the financial filings and compute the result. For example, to verify a claim about revenue growth, the system may generate an equation to calculate the percentage change in revenue between two periods, such as Revenue Growth=(Revenue_Current−Revenue_Prior)/Revenue_Prior×100.

In one embodiment, the system may resolve conflicting evidence by assigning respective weights to evidence data from different evidence sources and combining the evidence data based at least in part on the respective weights (e.g., by the conflict resolution module 323 shown in the example of FIG. 3A). For example, data from primary sources such as SEC filings may be assigned a higher weight than data from secondary sources such as news articles. In another embodiment, the system may evaluate another candidate assertion using the evaluation result of a logically related candidate assertion. For example, if a first assertion regarding net income has been verified, the system may use that result to inform evaluation of a second assertion regarding earnings per share.

In process 520, an evaluation record is generated for the candidate assertion that includes the evaluation result and/or identifiers of the evidence data (e.g., by the output and reporting module 325 of the verification engine 304 shown in the example of FIG. 3A). The evaluation result can include a verification status for the candidate assertion. The verification status may be one of: supported (indicating the candidate assertion is confirmed by the evidence data), contradicted (indicating the candidate assertion conflicts with the evidence data), not verifiable (indicating insufficient evidence data is available to evaluate the candidate assertion), or uncertain (indicating the evidence data is ambiguous or conflicting). A confidence score can be computed to indicate a likelihood that the verification status is correct. The confidence score may be compared to one or more tolerance thresholds to assess the verification status, where the tolerance threshold may be determined at least in part from an assertion type of the candidate assertion or from a policy.

As illustrated in the example of FIG. 2E, the system presents equation results and interpretation for each sub-component of a compound candidate assertion, including the calculated result, verification status, and category indicating whether the original financial fact was correct or incorrect. For example, for the current ratio sub-component, the system may display: the equation used (Current Ratio=Current Assets/Current Liabilities), the computed result (e.g., 2.0), the verification status (e.g., “The stated current ratio was 1.47, while the calculated result is 2”), and the category (e.g., “The financial fact was originally incorrect, but with the equation result, the correct financial fact was found, and we are able to correct the financial fact”). This granular presentation enables users to understand precisely where discrepancies exist within compound assertions.

In one embodiment, the system may generate a candidate assertion signature based at least in part on one or more properties of the candidate assertion and store the evidence data in a cache or knowledge base in association with the candidate assertion signature. The system may subsequently retrieve the evidence data from the cache when evaluating another candidate assertion having a matching candidate assertion signature, thereby avoiding redundant evidence retrieval for similar assertions. This caching capability can significantly improve performance when processing documents containing multiple assertions that reference the same underlying data.

In process 522, document-level metrics are determined based on evaluation results for multiple candidate assertions (e.g., by the document evaluation module 324 of the verification engine 304 shown in the example of FIG. 3A). As illustrated in the example of FIG. 2A, the system presents a summary showing the total number of facts checked (e.g., 59 facts) and a breakdown of verification statuses (e.g., 28 verified, 31 requiring attention). The document-level metrics can include, for example, an overall verification rate (percentage of assertions verified as supported), a contradiction rate (percentage of assertions verified as contradicted), a coverage rate (percentage of assertions for which sufficient evidence was available), and a confidence distribution (distribution of confidence scores across assertions).

In one embodiment, sections of the electronic content item are ranked based on the verification statuses of the multiple candidate assertions in the electronic content item. For example, a section containing a higher proportion of contradicted assertions may be ranked as requiring priority review. This ranking can help users focus their attention on the most problematic portions of a document. In another embodiment, the system may compute intermediate evaluation results based on respective subsets of the evidence data, enabling progressive disclosure of results as evidence is retrieved.

In process 524, a modified version of the electronic content item is generated when the evaluation result indicates contradiction or uncertainty (e.g., by the output and reporting module 325 shown in the example of FIG. 3A). Text associated with the candidate assertion can be annotated or rewritten to generate the modified version of the electronic content item. The annotation may include visual indicators such as highlighting, strikethrough, or marginal notes that identify assertions requiring attention. The rewriting may include replacement of incorrect values with correct values determined from the evidence data, insertion of qualifying language to indicate uncertainty, or addition of citations to the evidence sources.

As illustrated in the example of FIG. 2F, the system generates a final conclusion indicating that the entire fact falls into a particular category based on verification of all sub-components, identifying where the original financial facts were incorrect and providing the correct financial facts determined through equation results. For example, if the original assertion stated that “the current ratio was 1.47” but the evidence data indicates the current ratio was 2.0, the system may generate a rewritten assertion stating “the current ratio was 2.0” along with an annotation indicating the original value was incorrect. In one embodiment, the system can optionally generate charts to visualize the financial information, enhancing the understandability of the fact-check report. For example, as shown in the example of FIG. 2B, a bar chart may be generated to display the current ratio and quick ratio across multiple fiscal periods, enabling visual comparison of trends over time.

In process 526, the evaluation result and/or modified version of the electronic content item is presented to a user (e.g., via the evaluation presentation module 412 of the client device 402 shown in the example of FIG. 4A). As illustrated in the examples of FIGS. 2A-2F, the user interface provides multiple views for exploring the evaluation results, including: a project outputs view showing summary metrics and document-level results (e.g., FIG. 2A), a fact-check reasoning view with data visualizations such as bar charts comparing metrics across time periods (e.g., FIG. 2B), an evidence data reasoning view showing the decomposition steps and data source identification (e.g., FIG. 2C), an equation reasoning view showing the mathematical verification steps with formulas (e.g., FIG. 2D), an equation results view showing the verification status and category determinations for each sub-component (e.g., FIG. 2E), and a conclusion view showing the overall determination and corrected facts (e.g., FIG. 2F).

In one embodiment, the user may select a specific candidate assertion to view detailed reasoning and evidence (e.g., via the assertion selection module 414 shown in the example of FIG. 4A). The user interface may render annotations overlaid on the electronic content item to indicate verification status (e.g., via the annotation rendering module 416 shown in the example of FIG. 4A). In another embodiment, the system may generate an output including one or more of the electronic content item and display data corresponding to the evaluation record. The output may be formatted for various consumption modes, including interactive web display, downloadable report, programmatic API response, or integration with third-party document management systems.

In process 528, one or more tolerance thresholds or parameters of the verification strategy are adjusted based on user feedback (e.g., by the feedback capture module 420 of the client device 402 shown in FIG. 4A and/or the feedback and adaptation module 308 of the host server 300 shown in the example of FIG. 3A). In one embodiment, user feedback indicating a confirmation or override of the evaluation result is received, and the evaluation result is updated in response to the confirmation or the override. For example, a user may confirm that an assertion marked as “uncertain” is in fact correct based on domain expertise not available to the automated system. As another example, a user may override an assertion marked as “supported” if the user identifies an error in the system's reasoning.

The user feedback can be stored and used to adjust tolerance thresholds or tolerance parameters of the verification strategy for future verifications. For example, if users frequently override a particular type of assertion, the system may adjust the tolerance threshold for that assertion type to reduce false positives or false negatives. In one embodiment, the system supports a collaborative fact-checking framework that integrates human expertise with AI-driven verification, allowing human fact-checkers to provide input, review the agent's reasoning, manually perform verification where automated methods are insufficient, and provide feedback to improve the system's performance. This human-AI collaboration can enhance both accuracy and coverage of the verification process.

In one embodiment, application programming interfaces and streaming interfaces can be exposed that social platforms, content management systems, advertising systems, and moderation tools can integrate with directly (e.g., by the interface and serving module 310 of FIG. 3A). Posts, comments, advertisements, or other user-generated content can be passed through the verification pipeline automatically. Platform-specific affordances such as verification badges, warning labels, or programmatic webhook responses can be supported, enabling a host platform to flag, throttle, or label content based on verification results and confidence levels.

In one embodiment, the system can distinguish between static fact-checking and dynamic fact-checking. In static fact-checking, the electronic content item received in process 510 can represent fixed content such as a published report, and the evaluation result generated in process 520 can represent a point-in-time determination. In dynamic fact-checking, the candidate assertion can be tagged as referencing data that may change over time, for example, current stock prices, exchange rates, or metrics updated by periodic filings. For dynamic candidate assertions, the system can schedule periodic re-verification at configurable intervals or in response to events such as new filings becoming available. When re-verification produces a changed evaluation result, the system can update the evaluation record, adjust document-level metrics in process 522, regenerate modified content in process 524, and optionally notify the user.

In one embodiment, after individual candidate assertions have been evaluated in process 518, the system can perform a consistency-checking pass across all candidate assertions in the electronic content item or across a collection of related electronic content items. The consistency check can identify, for example, conflicting assertions about the same entity or time period, or missing elements and logical gaps. Results of the consistency check can be reflected in the document-level metrics of process 522 and can generate additional annotations in the modified version of the electronic content item in process 524.

In one embodiment, the electronic content item received in process 510 can include source code repositories, configuration files, or technical documentation containing embedded factual assertions. For example, a configuration file may include a comment stating “tax_rate=0.21 #current US federal corporate rate,” where the asserted tax rate can be verified against authoritative sources. Candidate assertions can be extracted from code comments, constant definitions, docstrings, or inline documentation as part of process 512.

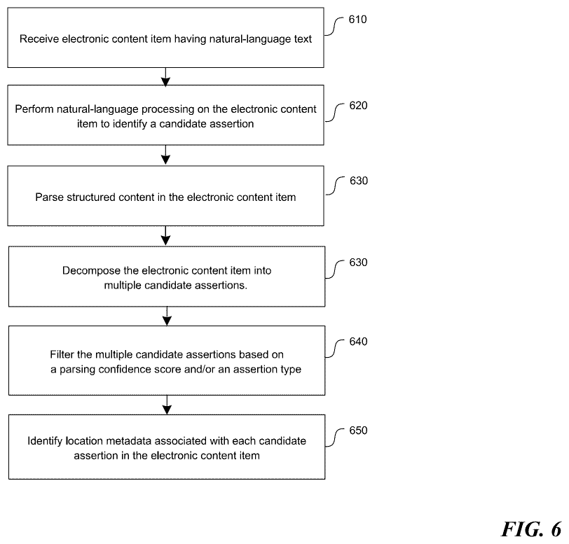

FIG. 6 depicts a flow chart illustrating an example process for identifying multiple candidate assertions in an electronic content item, in accordance with embodiments of the present disclosure.

FIG. 6 illustrates one embodiment of the assertion-identification phase referenced in process 512 of FIG. 5.

In process 610, the electronic content item received in process 510 is provided for assertion extraction (e.g., by the assertion extraction module 314 of the verification engine 304 shown in FIG. 3A). The electronic content item can include, for example, a financial report, a research memorandum, an earnings call transcript, or a regulatory filing that contains narrative sections and structured elements such as tables, bullet lists, and footnotes. In one embodiment, the electronic content item is segmented into sections, paragraphs, or pages to support efficient processing of long documents that may contain dozens or hundreds of factual statements.

In process 620, candidate assertion spans are identified in natural-language text of the electronic content item (e.g., by the assertion extraction module 314 of FIG. 3A using one or more natural-language processing techniques). The candidate assertion spans can be identified using one or more of sentence segmentation, dependency parsing, named-entity recognition, and pattern-based detection. The candidate assertion spans can also be identified using relationship extraction to build structured triples (entity-relation-entity) that become candidate assertions, particularly for claims such as “Company A acquired Company B” or “Drug X reduces Risk Y by 30%.” Sentiment analysis and subjectivity detection can be applied to help separate factual assertions from opinion-heavy language, feeding into the fact-or-opinion label and into downstream strategy determination.

For example, in an earnings commentary paragraph stating “Revenue grew 18% year-over-year, while EBITDA margin expanded from 22% to 27%,” separate candidate assertions can be identified for “Revenue grew 18% year-over-year” and “EBITDA margin expanded from 22% to 27%.” As another example, in a due diligence memorandum stating “The company has been free cash flow positive for the last four quarters,” a temporal assertion referencing a consecutive sequence of periods can be identified as a candidate assertion.

In process 630, structured content in the electronic content item is parsed to identify additional candidate assertions (e.g., by the assertion extraction module 314 of FIG. 3A). The structured content can include, for example, “Key Metrics” tables, financial statement tables, summary grids of ratios, or other tabular regions that encode factual values. Each cell or row in such structured content can be treated as a candidate assertion. For instance, a “Key Metrics” table listing “Current ratio: 2.0,” “Quick ratio: 1.4,” and “Net debt-to-EBITDA: 1.8x” for multiple fiscal periods can give rise to separate candidate assertions for each metric-period pair, even if those metrics are not repeated verbatim in the narrative text. In some embodiments, configuration blocks, log-style lines, or machine-generated summaries included in the document are also parsed to identify numeric or categorical values that can be verified.

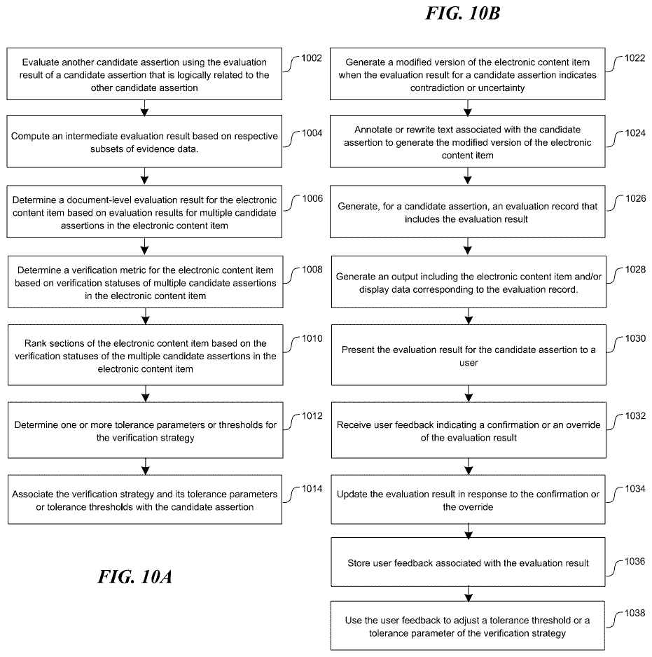

In process 640, compound candidate assertions are decomposed into multiple atomic candidate assertions that can be individually verified (e.g., by the assertion extraction module 314 of FIG. 3A). A compound candidate assertion can be, for example, a sentence that states multiple factual elements joined by conjunctions. For example, the sentence “The current ratio was 1.47 and the quick ratio was 0.93, indicating adequate liquidity” can be decomposed into a first atomic candidate assertion regarding the current ratio and a second atomic candidate assertion regarding the quick ratio, while the qualitative phrase “indicating adequate liquidity” may be excluded from automated verification. In one embodiment, implied assertions are also generated from structured content. For instance, when a table shows revenue of $1.0 billion in 2022 and $1.2 billion in 2023, implied candidate assertions that “revenue in 2022 was $1.0 billion,” “revenue in 2023 was $1.2 billion,” and “revenue grew 20% year-over-year” can be generated, enabling cross-checks between narrative statements and underlying tabular data as described in FIG. 10A.

In process 650, the identified candidate assertions are filtered and augmented with location metadata (e.g., by the assertion extraction module 314 and/or the document evaluation module 324 of FIG. 3A). Filtering can be based on one or more of a parsing confidence score or an assertion type. Candidate assertions whose parsing confidence falls below a configured threshold can be discarded or deprioritized for automated verification. Subjective or purely opinion-based statements can be excluded, while numeric, categorical, and temporal assertions are retained. Location metadata for each retained candidate assertion can include a document identifier, a section label (for example, “Executive Summary,” “Key Metrics,” or “Liquidity and Capital Resources”), a paragraph or sentence index, and character offsets within the original text. When the electronic content item is derived from a paginated or layouted source, the location metadata can further include page numbers and bounding box coordinates for the corresponding region in the rendered document. This location metadata enables later operations such as annotating the original content item, ranking sections based on verification status, and displaying fact-check reasoning views that highlight the specific sentences or table cells associated with each candidate assertion.

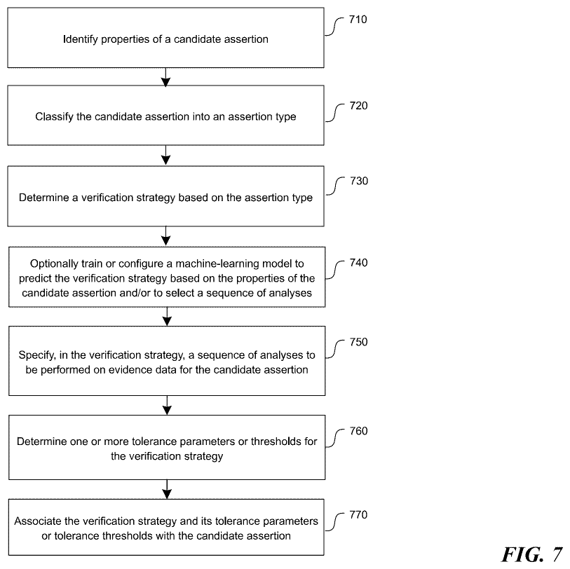

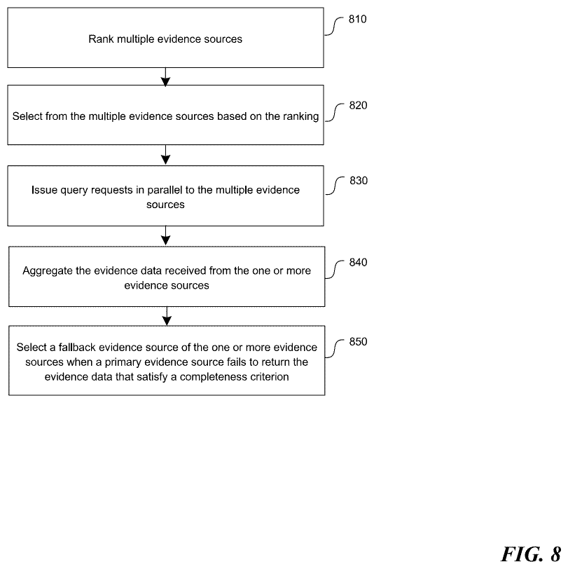

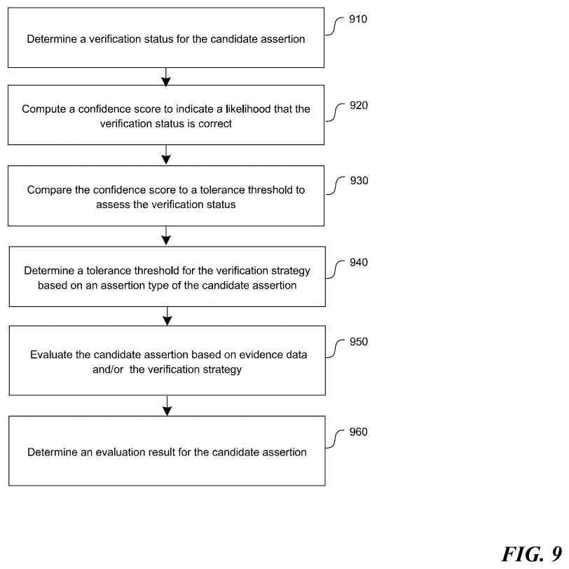

In one embodiment, the output of FIG. 6 includes a collection of candidate assertions, each represented by assertion text (or an internal representation), assertion type, any decomposed sub-assertions, parsing confidence, and location metadata. This collection is provided as input to the verification strategy determination process of FIG. 7 and the evidence retrieval and evaluation processes of FIGS. 8 and 9.

In one embodiment, the electronic content item received in process 610 can include multimedia content such as images, video, or audio, and candidate assertions can be extracted from the multimedia content in process 620. For image content, optical character recognition (OCR) can be applied to extract text from screenshots, scanned documents, slide images, or photographs (e.g., by the assertion extraction module 314 of FIG. 3A). For chart or graph images, image analysis can be applied to extract data points, axis labels, and legend entries. For video content, frames can be extracted and OCR can be applied to on-screen text, or audio tracks can be extracted for speech processing. For audio content such as recorded earnings calls or interviews, automatic speech recognition (ASR) can be applied to generate transcripts, and candidate assertions can then be identified from the transcribed text.

In one embodiment, the electronic content item received in process 610 can include source code, configuration files, or technical documentation, and candidate assertions can be extracted from code-related content in process 620. Code repositories can be parsed to identify factual statements in code comments, constant definitions, configuration values with descriptive annotations, or structured docstrings (e.g., by the assertion extraction module 314 of FIG. 3A). For example, a constant definition such as “MAX RETRY_COUNT=3//per API rate limit specification” can contain an implicit assertion that can be verified against the referenced documentation. The system can integrate with version control systems to ingest code files and can apply language-specific parsers to extract assertions from comments and documentation blocks.

In one embodiment, each candidate assertion identified in processes 620 through 640 can be assigned a classification that includes one or more of a fact-or-opinion label, a content category, and a source-type indicator (e.g., by the assertion extraction module 314 of FIG. 3A). The fact-or-opinion label can distinguish factual assertions that can be objectively verified from opinion-like assertions that express subjective judgments or recommendations. The content category can indicate the domain of the assertion, for example, financial metrics, legal statements, scientific claims, or product specifications. The content category can further indicate domain-specific subtypes such as medical or clinical claims, regulatory compliance statements, or platform integrity flags, enabling selection of domain-specific verification modules in the strategy determination process of FIG. 7. The source-type indicator can characterize the origin of the assertion, for example, narrative text, tabular data, quoted statement, or footnote. This classification can be used in the strategy determination process of FIG. 7 to select appropriate verification strategies tailored to each assertion type.

FIG. 7 depicts a flow chart illustrating an example process for determining a verification strategy for a candidate assertion, in accordance with embodiments of the present disclosure.

FIG. 7 illustrates one embodiment of the verification-strategy selection referenced in process 514 of FIG. 5.

In process 710, properties of a candidate assertion are received for strategy determination (e.g., by the strategy determination module 316 of the verification engine 304 shown in the example of FIG. 3A). The properties can include, for example, assertion text, a preliminary assertion type (such as numeric, categorical, or temporal), one or more resolved entities (such as company names, tickers, countries, or currencies), referenced time periods, and contextual information indicating where in the document the assertion appears (for example, in a “Key Metrics” section, an “Outlook” section, or a “Macro Assumptions” section). In one embodiment, metadata indicating whether the assertion appears in a headline, footnote, or forward-looking guidance section is also received, as these factors can influence which verification strategy is appropriate.

In process 720, the assertion type and related classification of the candidate assertion are determined based on the received properties (e.g., by the strategy determination module 316 of FIG. 3A). The classification can distinguish, for example, between backward-looking assertions (historical facts) and forward-looking assertions (guidance, projections, or scenario statements), as well as between numeric subtypes (such as absolute level, percentage growth, ratio, or ranking) and categorical subtypes (such as membership in a set or assignment of a label). For example, the assertion “Revenue grew 18% year-over-year in 2023” can be classified as a numeric, backward-looking growth assertion for a public company, whereas “Management expects revenue to grow at least 20% next year” can be classified as a numeric, forward-looking projection. As another example, the assertion “The company has the largest market share among its peer group” can be classified as a categorical ranking assertion that will require comparison across multiple entities.

In process 730, a verification strategy is selected for the candidate assertion based at least in part on the determined assertion type and the one or more properties (e.g., by the strategy determination module 316 of FIG. 3A). The verification strategy can specify, for example, which categories of evidence sources are to be used (such as regulatory filings, macroeconomic databases, benchmark indices, or curated knowledge bases), what normalization or transformation steps will be applied, and which equations or logic rules must be evaluated. For a backward-looking numeric growth assertion involving a public company, the verification strategy can specify that financial filings (e.g., SEC EDGAR 10-K or 10-Q reports) should be queried for revenue in two or more periods, that fiscal periods should be aligned, that the growth percentage should be computed from the retrieved values, and that the computed value should be compared with the asserted growth rate. For a categorical membership assertion such as “Country X is a member of the Eurozone,” the verification strategy can specify that membership lists from one or more authoritative central bank or international organization sources are to be queried and that a membership check is to be performed.

In one embodiment, domain-specific verification strategy modules can be selected, such as a financial module, a legal/compliance module, a scientific/medical module, a regulatory module, or a news/politics module (e.g., by the strategy determination module 316 of the example of FIG. 3A). Each domain-specific module can define preferred evidence sources, domain-specific heuristics (for example, how to validate clinical endpoints versus how to validate statutory citations), tolerance profiles, and explanation templates. Which domain-specific module or modules to apply can be stored per organization, per project, or per document section in a user repository (e.g., the user repository 328).

In process 740, one or more tolerance parameters or thresholds for the verification strategy are determined based at least in part on the assertion type or a policy (e.g., by the strategy determination module 316 and/or the knowledge base management module 306 of FIG. 3A). For numeric assertions, tolerance parameters can define acceptable deviation between derived values and asserted values. For example, very tight tolerances may be configured for audited financial figures reported in regulatory filings, while wider tolerances may be configured for survey-based macroeconomic estimates. For categorical assertions, tolerance rules can govern minor label variations or synonyms (for example, mapping “United States” and “U.S.” to the same canonical entity) when checking membership or equality. For temporal assertions, tolerance parameters can specify allowable offsets in days or months between stated dates and actual event dates, depending on context. In one embodiment, project-specific or customer-specific policies can be applied so that different tolerance profiles are used for different types of documents or use cases (for example, stricter tolerances for regulatory disclosures compared to internal draft materials).

In process 750, the selected verification strategy and the determined tolerance parameters are associated with the candidate assertion (e.g., by the strategy determination module 316 of FIG. 3A). The association can be stored as part of an internal representation of the candidate assertion such that downstream components can execute the specified strategy consistently. In one embodiment, a candidate assertion signature is generated or updated based at least in part on one or more properties of the candidate assertion and the associated verification strategy. The candidate assertion signature can be used as a key to cache evidence data and/or evaluation results so that when an identical or closely similar assertion is encountered again, previously retrieved evidence or a prior evaluation can be reused without repeating all retrieval and computation steps.

In process 770, one or more learned models and feedback signals are optionally used to refine the verification strategy or tolerance parameters (e.g., by the strategy determination module 316 in cooperation with the feedback and adaptation module 308 of the example of FIG. 3A). Historical evaluation outcomes and user feedback collected as described in FIG. 10B can be analyzed to learn patterns between assertion properties, strategies, and successful verification outcomes. For example, a learned model may recommend routing certain forward-looking statements directly to a strategy that emphasizes annotation rather than hard “supported/contradicted” labels, or may suggest narrower or wider tolerance thresholds for particular assertion types in specific domains. In one embodiment, recommendations from such models are used to automatically select a strategy template or to propose tolerance adjustments that can be accepted or overridden according to policy.

The result of the process illustrated in FIG. 7 is that each candidate assertion passed to the evidence source selection and retrieval process of FIG. 8 carries an explicit verification strategy and associated tolerance parameters that are tailored to its type, context, and policy environment, enabling consistent and transparent application of the downstream evidence retrieval and evaluation steps described in the examples of FIGS. 8 and 9.

In one embodiment, for a forward-looking or predictive assertion, the verification strategy determined in process 730 can specify that historical data is to be fetched, a predictive model is to be queried or constructed, and the asserted forecast is to be compared to model outputs and confidence intervals. For example, for an assertion stating “Management expects revenue to exceed $5 billion next year,” the verification strategy can specify retrieval of historical revenue figures, application of a trend-based or regression-based predictive model, and comparison of the asserted target against the model's predicted range. The evaluation result for such forward-looking assertions can include a plausibility assessment, for example, labels such as “plausible,” “aggressive,” or “unlikely” based on whether the asserted value falls within, above, or below the model's confidence intervals.

In one embodiment, predictive models and forecasts can be proactively built and/or stored in the a knowledge base repository (e.g., knowledge base repository 332), even when no specific forward-looking assertion is present in the electronic content item (e.g., by the strategy determination module 316 and/or the knowledge base management module 306 of the example of FIG. 3A). When new content later arrives containing forecast-like assertions, those assertions can be verified against the pre-computed predictions. Assertions that diverge materially from the stored forecasts can be proactively flagged. In dynamic fact-checking mode, re-evaluation can be scheduled when real-world outcomes become observable, thereby converting forecast checks into ex-post verifications over time.

In one embodiment, for an opinion-type assertion, the verification strategy determined in process 730 can specify that source attribution and context are to be verified rather than numeric accuracy. The verification strategy can specify that quoted text is to be verified against original statements, speaker identity and role are to be checked, and corroborating context is to be retrieved from authoritative sources. For example, for an assertion stating “The CEO stated that market conditions remain favorable,” the verification strategy can specify retrieval of the original transcript or press release, verification that the quoted language matches the original, and confirmation of the speaker's identity and role at the time of the statement.

In one embodiment, the verification strategy determined in process 730 can be parameterized by a grounding reference frame that defines which sources are authoritative, how strict tolerance thresholds should be, and what verification perspective applies. Different grounding reference frames can be configured for different use cases, for example, a “Regulatory Strict” frame for investor disclosures that requires primary sources and tight tolerances, an “Internal Draft Relaxed” frame for preliminary analyses that permits wider tolerances and secondary sources, or a “Marketing Review” frame that emphasizes brand and product claim verification. The grounding reference frame can be selected on a per-user, per-organization, per-document, or per-assertion basis. Each grounding reference frame can further encode bias preferences specifying which source bias profiles to favor or reject, where bias profiles are automatically inferred based on historical content such as stance on topics, politicization level, or sentiment trends. Both explicit user preferences (for example, “exclude tabloid sources” or “prefer peer-reviewed journals”) and automatically inferred bias characteristics can be jointly enforced when selecting evidence sources and setting tolerance thresholds (e.g., by the strategy determination module 316 and the evidence source selection module 318 of the example of FIG. 3A).

In one embodiment, the verification strategy and tolerance parameters determined in processes 730 and 740 can be influenced by a personalized fact-checking profile associated with the user or organization. The personalized profile can encode, for example, preferred data sources and source rankings, preferred strictness of tolerance thresholds, and domain-specific rules tailored to the user's or organization's verification requirements.

In one embodiment, for a logical or mathematical assertion, the verification strategy determined in process 730 can specify that the assertion is to be routed to a theorem-proving engine or symbolic reasoning system. The assertion can be encoded as a formula or set of premises, and formal logic techniques can be applied to prove or refute the assertion. The evaluation result can indicate whether the assertion is provable, whether counterexamples were found, or whether the result is indeterminate.

In one embodiment, the verification strategy determined in process 730 can specify use of a fuzzy-logic engine for assertions where discrete true-or-false labels are inadequate. Fuzzy membership functions can be applied to compute degrees of truth across multiple overlapping contexts, for example, when an assertion involves terms such as “substantial,” “significant,” or “approximately” that admit gradations rather than binary outcomes.

In one embodiment, the assertion type and classification determined in process 720 can include a fact-or-opinion label that was assigned during the assertion extraction process of the example of FIG. 6, and the verification strategy selected in process 730 can be tailored based on whether the candidate assertion is classified as a factual assertion or an opinion-type assertion (e.g., by the strategy determination module 316 of FIG. 3A). Factual assertions can be routed to strategies that emphasize numeric verification and evidence comparison, while opinion-type assertions can be routed to strategies that emphasize source attribution and context verification.

FIG. 8 depicts a flow chart illustrating an example process for selecting one or more evidence sources and/or retrieving evidence data for a candidate assertion, in accordance with embodiments of the present disclosure.

FIG. 8 illustrates one example embodiment of the evidence-source selection and retrieval portion of the verification flow referenced in processes 514 and 516 of the example of FIG. 5.

In process 810, multiple evidence sources are ranked (e.g., by the evidence source selection module 318 of the verification engine 304 shown in the example of FIG. 3A). The multiple evidence sources can include, for example, structured databases such as SEC's EDGAR database, company financial databases, internal data warehouses, curated knowledge base repositories, macroeconomic data providers, and, in some embodiments, specialized industry datasets. The ranking can be based on one or more of source reliability, recency of updates, domain coverage, historical consistency with other sources, or project-specific policies. For example, when verifying a financial assertion about a U.S. public company, EDGAR filings may be ranked higher than general web sources or news articles because they represent official regulatory disclosures. As another example, when verifying a macroeconomic statistic (such as an unemployment rate or GDP growth figure), government statistical agencies or central bank publications may be ranked above secondary aggregators. In one embodiment, the ranking may additionally consider latency or cost characteristics of each source so that sources that are slower or more expensive to query are used when necessary.

In one embodiment, the ranking can also be based on bias profiles automatically inferred for each evidence source, where bias profiles characterize attributes such as stance on topics, politicization level, sentiment trends, or industry sponsorship (e.g., by the evidence source selection module 318 of FIG. 3A). Each evidence source can be tagged with bias metadata (for example, “left-leaning,” “industry-sponsored,” or “tabloid”), and these tags can be used to weight, discount, or diversify sources during ranking. User-specified or organization-specified bias preferences (e.g., stored in the user repository 328) can further influence the ranking, for example, by deprioritizing sources with particular bias profiles or by requiring that selected sources include at least one source from each of multiple bias categories to ensure diversity of perspective.

In process 820, one or more evidence sources are selected from the multiple evidence sources based at least in part on the ranking (e.g., by the evidence source selection module 318 of FIG. 3A). The selection can also be influenced by properties of the candidate assertion and the verification strategy determined in the example of FIG. 7. For example, for a numeric assertion involving revenue growth of a publicly traded company, the selected evidence sources can include SEC EDGAR 10-K and 10-Q filings as primary sources, together with one or more company databases or internal curated financial datasets as secondary sources for redundancy. As another example, for a candidate assertion concerning a company's headcount or number of employees, the selected evidence sources may include company annual reports, investor presentations, and reputable company databases. In one embodiment, entity resolution may be performed before or during process 820 so that a company name, ticker symbol, or alternate identifier is mapped to a canonical entity identifier used by the selected evidence sources. This mapping can ensure that subsequent queries retrieve data for the correct entity even when different sources use different naming conventions.

In process 830, query requests are issued in parallel to the multiple selected evidence sources (e.g., by the evidence retrieval module 320 of the verification engine 304 shown in the example of FIG. 3A). Query requests can be constructed based on one or more properties of the candidate assertion and the associated verification strategy. For a numeric financial assertion, the query requests may specify the resolved company identifier, the relevant fiscal periods (such as FY2022 and FY2023), and one or more financial metrics (such as revenue, current assets, current liabilities, or inventory) required to compute equation-based checks (for example, equations for current ratio, quick ratio, or revenue growth). For a temporal assertion referencing consecutive profitable quarters, the query requests may specify the entity and a window of quarterly net income values across the referenced time range. The queries can be issued concurrently to reduce overall verification latency, so that data from EDGAR, a company database, and an internal knowledge base repository can be retrieved in parallel rather than sequentially. In one embodiment, the query requests may include constraints or projections so that only the fields needed for the planned equations or comparisons are retrieved, which can reduce bandwidth and processing overhead.

In process 840, the evidence data received from the one or more evidence sources is aggregated (e.g., by the evidence retrieval module 320 and/or the knowledge base management module 306 of FIG. 3A). Aggregation can include aligning and combining records that refer to the same entity and time period, reconciling differences in field naming, and discarding incomplete or malformed responses that do not meet basic validity checks. For example, if EDGAR returns annual revenue values and a company database returns quarterly revenue values, the system may aggregate the data into a unified internal structure that allows both annual and quarterly calculations. As another example, when verifying an assertion such as “revenue increased by 15% year-over-year,” the aggregated evidence data can include revenue values for at least two consecutive periods from multiple sources, enabling calculation of the actual percentage change and cross-comparison between sources. In one embodiment, aggregation may also include recording source-level metadata, such as which source provided which value and when it was last updated, so that later evaluation stages can weigh conflicting evidence according to source reliability and recency.

In one embodiment, the source-level metadata recorded during aggregation can include bias profile information for each source, and bias profiles can be used when assigning weights to conflicting evidence (e.g., by the evidence retrieval module 320 and/or the conflict resolution module 323 of the example of FIG. 3A). For example, when sources with aligned bias profiles provide values that differ from sources with opposing bias profiles, bias-aware weighting can be applied to avoid over-reliance on sources that share a common bias. Bias context can be surfaced to users in the evaluation record, for example, by indicating when a claim is supported only by sources with a particular bias profile or when selected sources exhibited bias diversity.

In process 850, a fallback evidence source is selected from the multiple evidence sources when a primary evidence source fails to return evidence data that satisfy a completeness criterion (e.g., by the evidence source selection module 318 and the evidence retrieval module 320 of the example of FIG. 3A). A completeness criterion can specify, for example, that certain required metrics, time periods, or data quality indicators must be present before evaluation can proceed. For instance, if a candidate assertion concerns current and quick ratios for a specific quarter, the completeness criterion may require that current assets, inventory, and current liabilities be available for that quarter. If EDGAR does not yet contain the latest quarterly filing or the filing omits a needed line item (for example, a particular subtotal or derived metric), the system may select a fallback evidence source such as a trusted financial data provider or an internal curated dataset that provides the missing fields. As another example, for a candidate assertion about a private company that does not file with EDGAR, the primary structured company database may fail completeness checks, and the system may fall back to an internal due diligence repository or a manually curated knowledge base of private-company financials. In one embodiment, the system may log the use of fallback sources and indicate in evaluation records that certain assertions were verified using secondary or tertiary sources, supporting transparency in the fact-checking report and allowing downstream users to understand when official filings were unavailable and alternative data had to be used.

In one embodiment, the aggregated evidence data resulting from processes 830, 840, and 850 can be normalized to a canonical representation as described with respect to process 518 of the example of FIG. 5, including converting units or currencies, aligning fiscal periods, and mapping textual categories into a shared taxonomy. The normalized, aggregated evidence data can then be provided to the evaluation process of FIG. 9, where equation-based verification, threshold comparisons, and conflict-resolution logic are applied to determine verification statuses and confidence scores for the candidate assertions.

In one embodiment, the multiple evidence sources ranked in process 810 can include sensor networks, telemetry feeds, IoT platforms, or real-time data streams (e.g., by the evidence source selection module 318 of FIG. 3A). For example, for a candidate assertion stating “Temperature in the storage facility remained below 25° C. throughout Q3,” the ranking can include IoT sensor logs or environmental monitoring systems as candidate evidence sources. Query requests issued in process 830 can specify time-window constraints aligned with the assertion's time period, and the evidence data aggregated in process 840 can include time-series sensor readings that enable verification of the asserted condition across the referenced interval.

In one embodiment, the multiple evidence sources ranked in process 810 can include external research agents or citation agents that can be invoked to perform specialized evidence gathering (e.g., by the evidence source selection module 318 of FIG. 3A). Query requests issued in process 830 can invoke a research agent to locate authoritative sources, conduct literature searches, or gather supporting documentation when the primary evidence sources do not provide sufficient coverage (e.g., by the evidence retrieval module 320 of FIG. 3A). Query requests can also invoke a citation agent to validate that cited sources genuinely support the asserted statement and to generate or verify citation metadata. Outputs from such agents can be integrated into the evidence data aggregated in process 840 and can be reflected in the evaluation record and fact-check report.

In one embodiment, when the candidate assertion references sources that are not explicitly cited or are incomplete, a research workflow can be triggered as part of processes 830 and 840 to locate candidate sources, rank them by relevance and reliability, and validate citations (e.g., by the evidence retrieval module 320 of FIG. 3A). For example, for an assertion stating “According to industry analysts, the market is expected to grow 12% annually,” a research agent can be invoked to identify which analysts or publications support the stated figure, retrieve the original analyst reports, and verify that the cited growth rate matches the source material. The evaluation record can indicate which citations were automatically discovered versus provided in the original content.

In a further embodiment, the multiple evidence sources ranked in process 810 can include multimedia repositories, and evidence data retrieved in processes 830 and 840 can include images, video, or audio that are analyzed to confirm or refute a textual assertion (e.g., by the evidence retrieval module 320 of FIG. 3A). For example, for a candidate assertion stating “The chart on page 12 shows revenue growth of 15%,” the system can retrieve the referenced chart image, apply image analysis to extract data points, and compare the extracted values against the asserted growth rate.

FIG. 9 depicts a flow chart illustrating an example process for evaluating a candidate assertion using evidence data and a verification strategy, in accordance with embodiments of the present disclosure.

FIG. 9 includes an example embodiment of the evaluation portion referenced in process 518 of the example of FIG. 5, focusing on how tolerance thresholds, verification statuses, and confidence scores are determined once evidence data has been retrieved and normalized.

In process 910, one or more tolerance thresholds are determined for the candidate assertion based at least in part on the assertion type and a verification policy (e.g., by the assertion evaluation module 322 in cooperation with the strategy determination module 316 and/or the knowledge base management module 306 of the verification engine 304 shown in the example of FIG. 3A).

The tolerance thresholds can include, for example, a primary threshold for classifying an assertion as supported, one or more thresholds for classifying assertions as contradicted, and optional “borderline” or “review” bands between supported and contradicted outcomes. For numeric financial assertions, the tolerance thresholds may specify how far a computed value can deviate from an asserted value while still being considered supported. For example, a policy for audited balance sheet metrics may require exact or near-exact matches (e.g., within rounding differences), whereas a policy for narrative commentary such as “approximately 15% revenue growth” may allow a wider deviation band. As another example, for macroeconomic statistics reported with confidence intervals, tolerance thresholds may be expressed relative to the reported interval (e.g., treating values within the published confidence range as supported and values outside that range as contradicted). In one embodiment, different tolerance profiles can be applied to different assertion contexts, so that assertions in a regulatory filing are subject to stricter thresholds than assertions in an informal blog post, even when both mention the same underlying metrics.

In process 920, the candidate assertion is evaluated based on the normalized evidence data and the verification strategy associated with the candidate assertion (e.g., by the assertion evaluation module 322 of FIG. 3A). The evaluation can include computing one or more derived values from the evidence data and comparing those derived values to the asserted values or relationships described in the candidate assertion. As described in process 518 of FIG. 5, the derived values may be obtained by applying equations or transformation rules that are selected based on the assertion type. For example, to evaluate an assertion regarding the current ratio and quick ratio, the system may compute:

$$\begin{matrix}Current Ratio = Current Assests / Current Liabilities \\ Quick Ratio = ( Current Assests - Inventory ) / Current Liabilities\end{matrix}$$

using current assets, inventory, and current liabilities retrieved from financial filings, and then compare the computed ratios with the asserted values (for example, “the current ratio was 1.47, and the quick ratio was 0.93”).

In one embodiment, the evaluation can include additional reasoning methods beyond equation-based verification (e.g., by the assertion evaluation module 322 of FIG. 3A). Statistical methods such as regression analysis, time-series analysis, hypothesis testing, or Benford's law checks can be applied to detect improbable patterns in reported metrics. Fraud detection algorithms and anomaly detectors trained on historical filings or transactions can be invoked to flag suspicious claims even when they nominally match outside data. Pattern recognition can be applied over sequences of reported numbers, textual phrasing, or reporting behaviors to detect potential manipulation. Argumentation mining and constraint-satisfaction solvers can be invoked to model multi-step arguments and verify that all premises and constraints are satisfied. These reasoning methods can be selected as optional sub-strategies based on the assertion type, for example, applying fraud-detection algorithms to fraud-sensitive financial claims or applying constraint-satisfaction reasoning to safety-critical technical claims.

As another example, to evaluate an assertion that “revenue increased by 15% year-over-year,” the system may compute:

$$Revenue Growth ( \% ) = ( Revenue\_Current - Revenue\_Prior ) / Revenue\_Prior \times 100$$

For the relevant periods, using revenue values retrieved from SEC EDGAR 10-K/10-Q filings or other selected evidence sources. In another example, to evaluate an assertion that “the company has been profitable for three consecutive quarters,” the system may examine net income values across the referenced quarters and determine whether all of the values are positive. In one embodiment, the evaluation may consider any normalization already applied to the evidence data, such as currency conversion, fiscal-period alignment, or taxonomy mapping, so that comparisons are made on a consistent basis.

In process 930, one or more deviations between the derived values and the asserted values are computed and compared against the tolerance thresholds (e.g., by the assertion evaluation module 322 of FIG. 3A). The deviations can include, for example, an absolute difference, a relative difference expressed as a percentage, or a ratio of derived value to asserted value. For a numeric growth assertion, the system can compute the difference between the computed growth rate and the asserted growth rate. For a ratio assertion, the system can compute the difference between the computed ratio (for example, a current ratio of 2.0) and the stated ratio (for example, 1.47). The system may then determine whether the computed differences fall within the configured tolerance bands for the assertion type and context. For instance, when verifying the statement “revenue increased by 15% year-over-year,” if the derived value is 14.7% and the tolerance band is ±1 percentage point, the deviation may be treated as within tolerance and thus consistent with “15%” in the context of narrative commentary. Conversely, if the derived value is 9% and the same tolerance band is applied, the deviation may be considered outside tolerance and indicative of a contradiction. In one embodiment, deviations may also be computed for relationships between multiple values (for example, “Company A's gross margin exceeded Company B's gross margin by 5 percentage points”), comparing the derived difference between margins to the asserted difference.

In process 940, a verification status is determined for the candidate assertion based at least in part on the deviations and the tolerance thresholds (e.g., by the assertion evaluation module 322 of FIG. 3A). The verification status may be, for example, supported, contradicted, not verifiable, or uncertain, as illustrated in FIG. 2E. An assertion may be classified as supported when the derived values fall within the configured support band, contradicted when the derived values fall outside a contradiction threshold, not verifiable when the required evidence data is missing or does not satisfy completeness criteria, and uncertain when the evidence data is present but inconsistent or ambiguous (for example, when different sources disagree significantly). For example, if the computed current ratio is 2.0 and the assertion states “the current ratio was 1.47,” the verification status for that sub-assertion may be contradicted. If the quick ratio assertion matches the computed value within tolerance, its status may be supported, allowing the system to later report that a compound assertion has mixed support. As another example, if the evidence sources provide conflicting revenue values for the same period that cannot be reconciled using source weights or normalization rules, the system may classify an assertion about revenue as uncertain rather than supported or contradicted.

In process 950, a confidence score is computed to indicate a likelihood that the determined verification status is correct (e.g., by the assertion evaluation module 322 and, optionally, a confidence scoring component of the verification engine 304 shown in FIG. 3A). The confidence score can be based on one or more factors, including the number of evidence sources that agree on the relevant values, the reliability rankings of those sources, the magnitude of deviations relative to tolerance bands, the stability of normalization steps, and the presence or absence of missing data. For instance, when multiple high-ranked sources (such as EDGAR filings and a trusted financial database) provide consistent values that, after normalization, yield a derived growth rate nearly identical to the asserted rate, the system may assign a high confidence score to a “supported” status. Conversely, if the assertion is evaluated based on a single secondary source because primary sources are unavailable, or if substantial normalization was required due to unusual fiscal year structures, the system may assign a lower confidence score, even if the assertion is classified as supported. As another example, when the system detects that different sources disagree and that conflict resolution required discarding outlier values, the confidence score may reflect the residual uncertainty in the remaining values.

In process 960, an evaluation result is generated for the candidate assertion based at least in part on the verification status and the confidence score (e.g., by the assertion evaluation module 322 of FIG. 3A). The evaluation result can include, for example, the verification status, the confidence score, one or more deviations between derived and asserted values, and references to the evidence data and tolerance thresholds used during evaluation. In one embodiment, the evaluation result may also include a category or explanation describing what happened during evaluation, similar to the categories shown in FIG. 2E (for example, “the financial fact was originally incorrect, but the correct value was determined from the equation result,” or “the financial fact was confirmed as correct based on the equation result”). These categories can help users understand not only whether an assertion is supported or contradicted, but also whether the system was able to compute a corrected value when the original value was wrong. In another embodiment, the evaluation result can encode information about which evidence sources and equations were used, and can be passed to subsequent processes, such as the document-level evaluation process of FIG. 10A and the evaluation-record generation and feedback process of FIG. 10B.

In one embodiment, the evaluation result generated in process 960 may be stored temporarily in memory or in a knowledge base repository in association with a candidate assertion signature, enabling reuse of the evaluation result when the same assertion or a semantically equivalent assertion appears in another portion of the document or in a different document. For example, if multiple sections of a financial report repeat the same liquidity statement, the system can reuse the prior evaluation rather than recomputing all equations and comparisons. The evaluation result may also be used as an intermediate input when evaluating logically related assertions as described in FIG. 10A, such as using a verified revenue assertion to help evaluate a subsequent assertion regarding revenue growth, or using a verified net income assertion when verifying an earnings per share assertion.

In one embodiment, the evaluation performed in process 920 can include methodology checking, where the system verifies not only that a computed value matches an asserted value, but also that the methodology used to derive the asserted value is consistent with a declared or standard methodology (e.g., by the assertion evaluation module 322 of FIG. 3A). For example, for an assertion stating “Adjusted EBITDA was $500 million,” the system can verify that the adjustments excluded from the EBITDA calculation match the adjustments declared in the document or match a standard definition stored in the knowledge base repository 332. If the assertion claims to use a particular methodology (such as excluding non-recurring items) but the evidence data indicates that different adjustments were applied, the verification status can reflect the methodology discrepancy even if the numeric value itself is accurate. The evaluation record generated in process 960 can indicate whether a methodology check was performed and whether the methodology was consistent with declared or standard definitions.

In one embodiment, the evaluation performed in process 920 can involve advanced financial modeling beyond simple ratio or single-step equation calculations (e.g., by the assertion evaluation module 322 of FIG. 3A). For assertions that require multi-step projections, scenario analysis, or sensitivity analysis, the system can load or construct a financial model as part of the evaluation. For example, for an assertion stating “Based on current trends, the company is expected to achieve profitability within three years,” the system can construct or query a multi-period financial model using historical data, apply trend-based projections, and determine whether the modeled outcomes are consistent with the asserted timeline. The evaluation result generated in process 960 can include model outputs, scenario ranges, and an indication of whether the assertion falls within, above, or below modeled expectations.

In one embodiment, the evaluation performed in process 920 can apply fuzzy membership functions to compute degrees of truth for assertions where discrete true-or-false labels are inadequate (e.g., by the assertion evaluation module 322 of FIG. 3A). For example, for an assertion stating “Revenue growth was substantial,” the system can apply a fuzzy membership function that maps computed growth rates to degrees of membership in the “substantial” category based on domain-specific definitions. The verification status determined in process 940 can reflect the computed degree of membership, and the confidence score computed in process 950 can incorporate uncertainty arising from the fuzzy evaluation. The evaluation result generated in process 960 can include the fuzzy membership value alongside the discrete verification status.

In a further embodiment, for a logical or mathematical assertion where the verification strategy specifies theorem proving, the evaluation performed in process 920 can include encoding the assertion as a formula or set of premises and applying formal logic techniques to prove or refute the assertion (e.g., by the assertion evaluation module 322 of FIG. 3A). The verification status determined in process 940 can indicate whether the assertion is provable, whether counterexamples were found, or whether the result is indeterminate. The evaluation result generated in process 960 can include the proof trace or counterexample as part of the reasoning record.

FIG. 10A depicts a flow chart illustrating an example process for document-level evaluation, in accordance with embodiments of the present disclosure.

FIG. 10A illustrates one example embodiment of the document-level and cross-assertion behavior referenced in process 522 of the example of FIG. 5.

In process 1002, evaluation results for multiple candidate assertions in an electronic content item are obtained (e.g., by the document evaluation module 324 of the verification engine 304 shown in FIG. 3A). The evaluation results can include, for example, the verification status and confidence score determined in process 960 of the example of FIG. 9 for each candidate assertion, as well as any intermediate values such as computed ratios, growth rates, or differences between entities. The evaluation results may correspond to assertions extracted from narrative sections, financial statement tables, “Key Metrics” summaries, and other structured regions. For instance, after evaluating all candidate assertions in a financial analysis report, the system can have evaluation results for statements regarding current and quick ratios, revenue growth, net income, leverage ratios, and qualitative narratives that were translated into numeric or categorical assertions.

In process 1004, cross-assertion relationships are identified and, in some embodiments, another candidate assertion is evaluated using the evaluation result of a candidate assertion that is logically related to the other candidate assertion (e.g., by the document evaluation module 324 of the example of FIG. 3A). Logical relationships can include, for example, a total versus its components, a narrative summary versus underlying table values, or a ranking statement versus multiple underlying metrics. For example, a report may contain a narrative assertion that “the company's total revenue is the sum of revenue from Product A and Product B,” as well as separate assertions about revenue for Product A and Product B in a table. If the assertions about Product A and Product B have already been evaluated and verified, process 1004 may use those verified values to compute the implied total revenue and compare it to the asserted total revenue, thereby evaluating the total-revenue assertion. As another example, the assertion “Company A has the highest gross margin in its peer group” can be evaluated using evaluation results for gross margin assertions for each peer company: the system can check whether the previously evaluated margins are consistent with the ranking claim.

In process 1006, one or more intermediate evaluation results are computed based on respective subsets of the evidence data or subsets of candidate assertions (e.g., by the document evaluation module 324 of FIG. 3A). Intermediate evaluation results can include, for example, per-section summaries, per-entity summaries, or per-metric summaries that aggregate or synthesize evaluations across multiple assertions. In one embodiment, the system may compute a “liquidity subsummary” that aggregates evaluations for all assertions related to current ratio, quick ratio, and cash balances, and a separate “profitability subsummary” that aggregates evaluations for assertions related to net income, margins, and return measures. As another example, the system may compute an intermediate result for all assertions concerning a particular fiscal period (for example, all Q3 2023 assertions) and then use that intermediate result when evaluating a higher-level narrative assertion such as “Q3 2023 performance substantially improved across key metrics.” These intermediate results can make it easier to reason about higher-level statements that depend on multiple lower-level assertions, and can also be surfaced in user interfaces that show metric-specific or section-specific verification snapshots.

In process 1008, one or more document-level evaluation results are determined for the electronic content item based at least in part on evaluation results for the multiple candidate assertions (e.g., by the document evaluation module 324 of FIG. 3A). A document-level evaluation result can include, for example, an overall veracity or credibility score for the document, along with category-level or topic-level scores. As illustrated in FIG. 2A, the system may determine, for a financial report, that a total of 59 facts were checked, with 28 facts verified and 31 facts requiring attention. From these per-assertion results, the system may compute an overall verification rate (such as the fraction of supported assertions), a contradiction rate (such as the fraction of contradicted assertions), and a coverage rate (such as the fraction of assertions for which sufficient evidence was available to attempt verification). The system may also compute separate document-level results for different themes, such as liquidity, profitability, leverage, and growth, by aggregating evaluation results for assertions assigned to those categories.

In process 1010, one or more verification metrics are determined for the electronic content item and sections of the electronic content item are ranked based on the verification statuses of the multiple candidate assertions (e.g., by the document evaluation module 324 and/or the output and reporting module 325 of FIG. 3A). Verification metrics can include, for example, counts and percentages of supported, contradicted, not verifiable, and uncertain assertions; distributions of confidence scores; and metrics that weight assertions by importance (for example, giving more weight to assertions in executive summaries or headline statements). The system can determine, for each section of the document (such as “Executive Summary,” “Key Metrics,” “Management Discussion and Analysis,” “Risk Factors”), how many assertions were verified and how many require attention. For example, a section that contains ten candidate assertions of which eight are contradicted and two are uncertain may be ranked as high priority for review, while a section with twenty assertions all verified as supported may be ranked as lower priority. As illustrated in FIG. 2A, such metrics may be displayed to the user as a summary of “facts checked” and “facts to review,” along with section-level indicators that help the user quickly identify which portions of the document are most problematic.

In process 1012, document-level evaluation results and verification metrics are optionally used to refine or adjust one or more tolerance parameters or thresholds of the verification strategy for subsequent assertions or documents (e.g., by the document evaluation module 324 in cooperation with the feedback and adaptation module 308 of FIG. 3A). For example, if the system detects that a large number of assertions of a particular type are being marked as contradicted by a small margin just outside a tolerance band, and if user feedback later confirms that many of those assertions should be considered acceptable in a given project context, the system may recommend adjusting the tolerance band for that assertion type in that context. As another example, if certain sections of documents (such as “Outlook” or “Forward-Looking Statements”) consistently contain a high fraction of uncertain or not verifiable assertions due to their predictive nature, the system may apply a different treatment to those sections, emphasizing annotation and explanation rather than strong supported/contradicted labels. These adjustments can be applied at a document level, project level, or policy level, and may influence the verification strategies used in future runs as described in FIG. 7.

In one embodiment, the document-level evaluation results and ranking information produced by FIG. 10A can be used by the output and reporting module 325 and the evaluation presentation module 412 (FIG. 4A) to generate the project outputs view and related user interface elements. For example, a user may see a summary card indicating that “59 facts were checked; 28 were verified; 31 require attention,” together with a list of sections sorted by the severity of issues, and can then drill down into the specific assertions and equation reasoning views described in FIGS. 2B-2F. The cross-assertion logic from process 1004 and the intermediate summaries from process 1006 may also be surfaced as explanations showing, for example, how a statement about “total revenue” was checked by comparing it to the sum of segment revenues, or how a claim about “highest margin” was evaluated across multiple peers.

In one embodiment, after evaluation results for the multiple candidate assertions have been obtained in process 1002, a consistency-checking pass can be performed across all candidate assertions in the electronic content item or across a collection of related electronic content items (e.g., by the document evaluation module 324 of FIG. 3A). The consistency check can identify, for example, conflicting assertions about the same entity or time period, missing elements, or logical gaps between related assertions. For example, if one assertion states “Q3 revenue was $1.2 billion” and another assertion in the same document states “Q3 revenue increased 10% from Q2 revenue of $1.0 billion,” the consistency check can verify that the two assertions are mathematically consistent (since $1.0 billion plus 10% equals $1.1 billion, not $1.2 billion). Results of the consistency check can be reflected in the document-level evaluation results of process 1008 and can generate additional annotations indicating inter-assertion inconsistencies.

In one embodiment, for candidate assertions that were tagged as dynamic during the strategy determination process of FIG. 7, the document-level evaluation process can include scheduling or triggering re-verification when underlying data changes (e.g., by the document evaluation module 324 in cooperation with the feedback and adaptation module 308 of FIG. 3A). When re-verification produces a changed evaluation result for a dynamic assertion, the document-level metrics computed in process 1008 can be updated, the verification metrics computed in process 1010 can be recalculated, and the user can optionally be notified that previously verified assertions have changed status. The evaluation record can track the last-verified timestamp for dynamic assertions and can indicate when an assertion's status changed due to updated evidence data.

FIG. 10B depicts a flow chart illustrating an example process for generating evaluation records in accordance with embodiments of the present disclosure.

FIG. 10B illustrates an example of the output, presentation, and feedback behavior referenced in processes 520, 524, 526, and 528 of the example of FIG. 5.

In process 1022, an evaluation record is generated for a candidate assertion based at least in part on an evaluation result determined as described in FIG. 9 (e.g., by the output and reporting module 325 of the verification engine 304 shown in FIG. 3A). The evaluation record can include, for example, the candidate assertion text or an internal representation, the verification status (such as supported, contradicted, not verifiable, or uncertain), a confidence score, one or more deviations between asserted and derived values, the tolerance thresholds that were applied, and identifiers of evidence data used during evaluation. The evaluation record may also include structured reasoning information that can be displayed to a user, such as the equations that were applied, the intermediate values computed, and a category describing how the assertion was handled. As illustrated in FIG. 2E, an evaluation record for a compound liquidity assertion can include per-sub-assertion entries indicating that the original current ratio value was incorrect but the correct value was determined from the equation result, while the quick ratio value was originally correct. In one embodiment, the evaluation record is stored in an evaluation record repository (for example, evaluation record repository 431 shown in FIG. 4B) and linked to the corresponding candidate assertion, document identifier, and candidate assertion signature so that it can be retrieved later for display or reuse.

In process 1024, output data including one or more electronic content items and display data corresponding to the evaluation records is generated (e.g., by the output and reporting module 325 of the verification engine 304 and the evaluation presentation module 412 of the client device 402 shown in the example of FIG. 4A). The output data can include, for example, a project-level summary view, fact-check reasoning views for individual assertions, equation reasoning views, evidence data views, and final conclusion views as described in FIGS. 2A-2F. In one embodiment, the display data specifies, for each candidate assertion, how it should be annotated in the original document (for example, color coding or icons indicating “verified,” “requires review,” or “not verifiable”), and how detailed reasoning panes should be rendered when a user selects a particular assertion. The output data may also be formatted as a machine-readable API response for integration with other systems, such as a research platform or a document management system, so that fact-check results can be consumed programmatically rather than only through an interactive user interface.

In process 1026, the evaluation results are presented to a user (e.g., by the evaluation presentation module 412 and the annotation rendering module 416 of the client device 402 shown in the example of FIG. 4A). Presentation can include rendering a project outputs view that shows document-level metrics (such as “59 facts checked,” “28 verified,” and “31 requiring attention,” as in FIG. 2A), as well as overlaying annotations on the electronic content item to indicate the verification status of individual assertions. For example, candidate assertions that are supported may be highlighted in one color, assertions that are contradicted may be highlighted in another color, and assertions that are not verifiable or uncertain may be marked with an icon indicating that further review is needed. In one embodiment, the user can select a highlighted assertion to open a fact-check reasoning view (such as the example of FIG. 2B) that displays, for example, bar charts of current ratio and quick ratio across multiple periods, or an equation reasoning view (such as FIG. 2D) that shows the formulas and intermediate values used to verify the assertion. The presentation can thus allow the user to move from a high-level summary down into the detailed reasoning behind each evaluation.

In process 1030, user interaction with the presented evaluation results is supported so that detailed reasoning and evidence can be inspected and, in some embodiments, exported (e.g., by the assertion selection module 414 and the evaluation presentation module 412 of FIG. 4A). A user may, for example, click on an assertion in the “facts requiring attention” list to see exactly which equation failed and by how much, or may expand a panel to see which filings or data sources were used to calculate a metric. The user can also navigate between sub-components of a compound assertion to see which parts were correct and which were incorrect. In one embodiment, the user interface may permit export of a fact-check report in a document format (such as a PDF or spreadsheet) that includes the evaluation records, equations, and corrected values, which can be attached to an internal review memo or provided to stakeholders as part of a diligence package.

In process 1032, user feedback indicating a confirmation or an override of an evaluation result is received (e.g., by the feedback capture module 420 of the client device 402 and provided to the feedback and adaptation module 308 of the host server 300 shown in the example of FIG. 3A). User feedback can include, for example, a user marking an assertion as “confirmed” when they agree with the system's supported or contradicted status, or marking an assertion as “override” when they disagree and provide a justification or alternative value. As one example, an analyst reviewing a private-company report may override a “contradicted” status for a revenue assertion after providing updated revenue data from an internal data room that was not accessible to the automated system. As another example, a compliance reviewer may change a “supported” status to “requires manual review” if the assertion is sensitive or governed by a stricter internal policy. In one embodiment, the user may be able to attach comments or upload additional evidence when providing feedback, and these attachments can be stored alongside the evaluation record.

In process 1034, the evaluation result for the candidate assertion is updated based on the received user feedback (e.g., by the feedback and adaptation module 308 and the output and reporting module 325 of the example of FIG. 3A). Updating the evaluation result can include changing the verification status (for example, from contradicted to supported), adjusting the confidence score, or flagging the assertion as “resolved by human override.” The updated evaluation result may be written back to the evaluation record repository so that subsequent views and reports reflect the human-reviewed outcome rather than the initial automated outcome. For instance, after an override, a subsequent load of the fact-check reasoning view for the same document may show the assertion as supported based on a “manual confirmation” tag, with a note indicating that the conclusion was adjusted by a reviewer using additional evidence. In one embodiment, the system can retain both the original automated evaluation and the updated evaluation for audit purposes, along with an indication of which user performed the override and when.

In process 1036, user feedback is stored and associated with the evaluation record, the candidate assertion signature, and, optionally, one or more policy contexts (e.g., by the feedback and adaptation module 308 and the knowledge base management module 306 of the example of FIG. 3A). The stored feedback can include structured signals (such as “override from contradicted to supported”) and unstructured comments (such as an analyst explanation), as well as metadata identifying the role of the user (for example, analyst, portfolio manager, compliance reviewer) and the project or client context. This stored feedback may be used to analyze patterns of disagreements between automated evaluations and human judgments. For example, the system may detect that assertions about certain types of non-GAAP metrics are frequently overridden, or that assertions in specific sections (such as forward-looking statements) are often reclassified as “requires manual review.” Such patterns can be used to refine verification strategies, as described in process 1038.

In process 1038, one or more tolerance thresholds or parameters of the verification strategy are adjusted based at least in part on the stored user feedback (e.g., by the feedback and adaptation module 308 in cooperation with the strategy determination module 316 of FIG. 3A). Adjustments can be made at different granularities. For example, tolerance bands for certain assertion types may be widened or narrowed in a particular project or domain when reviewers consistently override the automated decisions in the same direction. In another example, policy rules may be updated so that certain categories of assertions (such as forward-looking growth targets or scenario analysis) are no longer labeled as strictly “supported” or “contradicted” but instead are automatically categorized as “annotated projections” requiring human review. In one embodiment, the system can also use the feedback to train or fine-tune models that assist in strategy selection, so that future candidate assertions with similar properties are more likely to be assigned a strategy and tolerance profile that aligns with historical human decisions. Over time, this feedback-driven adaptation can improve both precision and recall of the automated verification process, while keeping humans in control of final judgments for critical or nuanced assertions.

In one embodiment, the processes of FIG. 10B support a collaborative fact-checking workflow that combines automated evaluation with human oversight. Automated evaluation can rapidly process large volumes of assertions, generate detailed equation reasoning, and propose corrected values when original figures are incorrect. Human reviewers can then use the presentation and feedback capabilities to focus on higher-risk assertions, validate the system's reasoning, correct any misclassifications, and encode their domain expertise back into the system through overrides and comments. The combination of evaluation records, presentation views, and feedback-driven adaptation can provide a transparent, auditable, and continuously improving fact-checking environment for financial analysis, due diligence, research reports, and other document types containing factual assertions to be verified.

In one embodiment, the presentation and interaction capabilities of processes 1026 and 1030 can support interactive explanation and exploration, where users can dynamically select which evidence sources, time ranges, or equations to display, and can explore alternative reasoning paths (e.g., by the assertion selection module 414 and the evaluation presentation module 412 of FIG. 4A). For example, a user can expand or collapse evidence panels, filter displayed evidence by source, switch between alternative reasoning paths that use different evidence sources or different normalization assumptions, and trigger re-checks with modified parameters such as different tolerance thresholds or different fiscal period alignments. The user interface can support exploratory workflows where a user can ask “what if” questions, such as “what if I exclude this data source” or “what if I use a stricter tolerance,” and can see how the evaluation result would change.

In one embodiment, the feedback capabilities of processes 1032 through 1038 can support community-based fact-checking, where feedback from multiple users is aggregated to influence evaluation records and verification strategies (e.g., by the feedback and adaptation module 308 of FIG. 3A). Multiple users can contribute feedback to the same evaluation record, and the system can aggregate feedback across users to compute community-level indicators such as consensus scores, disagreement flags, or vote counts. For example, if multiple reviewers independently confirm that an assertion is supported, the confidence score for that assertion can be increased. If reviewers disagree about the correct status, the system can flag the assertion for escalation or additional review. The aggregated community feedback can be used to update policies, adjust tolerance thresholds, or refine source rankings to reflect collective judgments across the user community.

In a further embodiment, for opinion-type assertions, the user feedback received in process 1032 can indicate whether the source attribution was accurate, whether the quoted text matched the original, or whether the context was misrepresented, rather than indicating numeric contradiction (e.g., by the feedback capture module 420 of FIG. 4A). The feedback stored in process 1036 can be tagged with the opinion-type classification so that patterns of feedback for opinion assertions can be analyzed separately from patterns for factual assertions.

FIG. 11 is a block diagram illustrating an example of a software architecture 2100 that may be installed on a machine, in accordance with embodiments of the present disclosure.

FIG. 11 is a block diagram 2100 illustrating an architecture of software 2102, which can be installed on any one or more of the devices described above. FIG. 11 is a non-limiting example of a software architecture, and it will be appreciated that many other architectures can be implemented to facilitate the functionality described herein. In various embodiments, the software 2102 is implemented by hardware such as machine 2200 of FIG. 12 that includes processors 2210, memory 2230, and input/output (I/O) components 2250. In this example architecture, the software 2102 can be conceptualized as a stack of layers where each layer may provide a particular functionality. For example, the software 2102 includes layers such as an operating system 2104, libraries 2106, frameworks 2108, and applications 2110. Operationally, the applications 2110 invoke API calls 2112 through the software stack and receive messages 2114 in response to the API calls 2112, in accordance with some embodiments. In one example, the verification engine 304 operates as an application 2110.

In some embodiments, the operating system 2104 manages hardware resources and provides common services. The operating system 2104 includes, for example, a kernel 2120, services 2122, and drivers 2124. The kernel 2120 acts as an abstraction layer between the hardware and the other software layers consistent with some embodiments. For example, the kernel 2120 provides memory management, processor management (e.g., scheduling), component management, networking, and security settings, among other functionality. The services 2122 can provide other common services for the other software layers. The drivers 2124 are responsible for controlling or interfacing with the underlying hardware, according to some embodiments. For instance, the drivers 2124 can include display drivers, camera drivers, BLUETOOTH drivers, flash memory drivers, serial communication drivers (e.g., Universal Serial Bus (USB) drivers), WI-FI® drivers, audio drivers, power management drivers, and so forth.

In some embodiments, the libraries 2106 provide a low-level common infrastructure utilized by the applications 2110. The libraries 2106 can include system libraries 2130 (e.g., C standard library) that can provide functions such as memory allocation functions, string manipulation functions, mathematic functions, and the like. In addition, the libraries 2106 can include API libraries 2132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 2106 can also include a wide variety of other libraries 2134 to provide many other APIs to the applications 2110.

The frameworks 2108 provide a high-level common infrastructure that can be utilized by the applications 2110, according to some embodiments. For example, the frameworks 2108 provide various graphic user interface (GUI) functions, high-level resource management, high-level location services, and so forth. The frameworks 2108 can provide a broad spectrum of other APIs that can be utilized by the applications 2110, some of which may be specific to a particular operating system 2104 or platform.

In an example embodiment, the applications 2110 include a home application 2150, a contacts application 2152, a browser application 2154, a search/discovery application 2156, a location application 2158, a media application 2160, a messaging application 2162, a game application 2164, and other applications such as a third-party application 2166. According to some embodiments, the applications 2110 are programs that execute functions defined in the programs. Various programming languages can be employed to create one or more of the applications 2110, structured in a variety of manners, such as object-oriented programming languages (e.g., Objective-C, Java, or C++) or procedural programming languages (e.g., C or assembly language). In a specific example, the third-party application 2166 (e.g., an application developed using the Android, Windows or iOS. software development kit (SDK) by an entity other than the vendor of the particular platform) may be mobile software running on a mobile operating system such as Android, Windows or iOS, or another mobile operating system. In this example, the third-party application 2166 can invoke the API calls 2112 provided by the operating system 2104 to facilitate functionality described herein.

A candidate assertion verification application 2167 may implement any system or method described herein, including integration of augmented, alternate, virtual and/or mixed realities for digital experience enhancement, or any other operation described herein.

FIG. 12 is a block diagram illustrating components of a machine 2200, according to some example embodiments, able to read a set of instructions from a machine-readable medium (e.g., a machine-readable storage medium) and perform any one or more of the methodologies discussed herein.

Specifically, FIG. 12 shows a diagrammatic representation of the machine 2200 in the example form of a computer system, within which instructions 2216 (e.g., software, a program, an application, an applet, an app, or other executable code) for causing the machine 2200 to perform any one or more of the methodologies discussed herein can be executed. Additionally, or alternatively, the instruction can implement any module of FIG. 3A and any module of FIG. 4A, and so forth. The instructions transform the general, non-programmed machine into a particular machine programmed to carry out the described and illustrated functions in the manner described.

In alternative embodiments, the machine 2200 operates as a standalone device or can be coupled (e.g., networked) to other machines. In a networked deployment, the machine 2200 may operate in the capacity of a server machine or a client machine in a server-client network environment, or as a peer machine in a peer-to-peer (or distributed) network environment. The machine 2200 can comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a head mounted device, a smart lens, goggles, smart glasses, a smart home device (e.g., a smart appliance), other smart devices, a web appliance, a network router, a network switch, a network bridge, a Blackberry, a processor, a telephone, a web appliance, a console, a hand-held console, a (hand-held) gaming device, a music player, any portable, mobile, hand-held device or any device or machine capable of executing the instructions 2216, sequentially or otherwise, that specify actions to be taken by the machine 2200. Further, while only a single machine 2200 is illustrated, the term “machine” shall also be taken to include a collection of machines 2200 that individually or jointly execute the instructions 2216 to perform any one or more of the methodologies discussed herein.

The machine 2200 can include processors 2210, memory/storage 2230, and I/O components 2250, which can be configured to communicate with each other such as via a bus 2202. In an example embodiment, the processors 2210 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, processor 2212 and processor 2214 that may execute instructions 2216. The term “processor” is intended to include multi-core processor that may comprise two or more independent processors (sometimes referred to as “cores”) that can execute instructions contemporaneously. Although FIG. 12 shows multiple processors, the machine 2200 may include a single processor with a single core, a single processor with multiple cores (e.g., a multi-core processor), multiple processors with a single core, multiple processors with multiples cores, or any combination thereof.

The memory/storage 2230 can include a main memory 2232, a static memory 2234, or other memory storage, and a storage unit 2236, both accessible to the processors 2210 such as via the bus 2202. The storage unit 2236 and memory 2232 store the instructions 2216 embodying any one or more of the methodologies or functions described herein. The instructions 2216 can also reside, completely or partially, within the memory 2232, within the storage unit 2236, within at least one of the processors 2210 (e.g., within the processor's cache memory), or any suitable combination thereof, during execution thereof by the machine 2200. Accordingly, the memory 2232, the storage unit 2236, and the memory of the processors 2210 are examples of machine-readable media.

As used herein, the term “machine-readable medium” or “machine-readable storage medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” or “machine-readable storage medium” should be taken to include a single medium or multiple media (e.g., a centralized or distributed database, or associated caches and servers) able to store instructions 2216. The term “machine-readable medium” or “machine-readable storage medium” shall also be taken to include any medium, or combination of multiple media, that is capable of storing, encoding or carrying a set of instructions (e.g., instructions 2216) for execution by a machine (e.g., machine 2200), such that the instructions, when executed by one or more processors of the machine 2200 (e.g., processors 2210), cause the machine 2200 to perform any one or more of the methodologies described herein. Accordingly, a “machine-readable medium” or “machine-readable storage medium” refers to a single storage apparatus or device, as well as “cloud-based” storage systems or storage networks that include multiple storage apparatus or devices. The term “machine-readable medium” or “machine-readable storage medium” excludes signals per se.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The I/O components 2250 can include a wide variety of components to receive input, provide output, produce output, transmit information, exchange information, capture measurements, and so on. The specific I/O components 2250 that are included in a particular machine will depend on the type of machine. For example, portable machines such as mobile phones will likely include a touch input device or other such input mechanisms, while a headless server machine will likely not include such a touch input device. It will be appreciated that the I/O components 2250 can include many other components that are not shown in FIG. 12. The I/O components 2250 are grouped according to functionality merely for simplifying the following discussion and the grouping is in no way limiting. In example embodiments, the I/O components 2250 can include output components 2252 and input components 2254. The output components 2252 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2254 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), eye trackers, and the like.

In further example embodiments, the I/O components 2250 can include biometric components 2256, motion components 2258, environmental components 2260, or position components 2262 among a wide array of other components. For example, the biometric components 2256 can include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram based identification), and the like. The motion components 2258 can include acceleration sensor components (e.g., an accelerometer), gravitation sensor components, rotation sensor components (e.g., a gyroscope), and so forth. The environmental components 2260 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 2262 can include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 2250 may include communication components 2264 operable to couple the machine 2200 to a network 2280 or devices 2270 via a coupling 2282 and a coupling 2272, respectively. For example, the communication components 2264 include a network interface component or other suitable device to interface with the network 2280. In further examples, communication components 2264 include wired communication components, wireless communication components, cellular communication components, Near Field Communication (NFC) components, Bluetooth components (e.g., Bluetooth. Low Energy), WI-FI components, and other communication components to provide communication via other modalities. The devices 2270 may be another machine or any of a wide variety of peripheral devices (e.g., a peripheral device coupled via a USB).

The network interface component can include one or more of a network adapter card, a wireless network interface card, a router, an access point, a wireless router, a switch, a multilayer switch, a protocol converter, a gateway, a bridge, bridge router, a hub, a digital media receiver, and/or a repeater.

The network interface component can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Moreover, the communication components 2264 can detect identifiers or include components operable to detect identifiers. For example, the communication components 2264 can include Radio Frequency Identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 2624, such as location via Internet Protocol (IP) geo-location, location via WI-FI signal triangulation, location via detecting a BLUETOOTH or NFC beacon signal that may indicate a particular location, and so forth.

In various example embodiments, one or more portions of the network 2280 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 2280 or a portion of the network 2280 may include a wireless or cellular network, and the coupling 2272/2282 may be a Code Division Multiple Access (CDMA) connection, a Global System for Mobile communications (GSM) connection, or other type of cellular or wireless coupling. In this example, the coupling 2272/2282 can implement any of a variety of types of data transfer technology, such as Single Carrier Radio Transmission Technology, Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, 5G, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 2216 can be transmitted or received over the network 2280 using a transmission medium via a network interface device (e.g., a network interface component included in the communication components 2264) and utilizing any one of a number of transfer protocols (e.g., HTTP). Similarly, the instructions 2216 can be transmitted or received using a transmission medium via the coupling 2272 (e.g., a peer-to-peer coupling) to devices 2270. The term “transmission medium” shall be taken to include any intangible medium that is capable of storing, encoding, or carrying the instructions 2216 for execution by the machine 2200, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the innovative subject matter has been described with reference to specific example embodiments, various modifications and changes may be made to these embodiments without departing from the broader scope of embodiments of the present disclosure. Such embodiments of the novel subject matter may be referred to herein, individually or collectively, by the term “innovation” merely for convenience and without intending to voluntarily limit the scope of this application to any single disclosure or novel or innovative concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, 16, other aspects may likewise be embodied as a means-plus-function claim, or in other forms, such as being embodied in a computer-readable medium. (Any claims intended to be treated under 35 U.S.C. § 112, 16 will begin with the words “means for”.) Accordingly, the applicant reserves the right to add additional claims after filing the application to pursue such additional claim forms for other aspects of the disclosure.

What is claimed is:

1. A method to verify a candidate assertion in an electronic content item, the method, comprising:
identifying, by a processor, in the electronic content item having natural-language text, the candidate assertion in the electronic content item to be fact verified;
determining, by the processor, a verification strategy for the candidate assertion based at least in part on one or more properties of the candidate assertion;
selecting, by the processor, one or more evidence sources based at least in part on the verification strategy;
retrieving, by the processor, evidence data from the one or more evidence sources;
evaluating, by the processor, the candidate assertion based at least in part on the evidence data and the verification strategy to determine an evaluation result for the candidate assertion.

2. The method of claim 1, further comprising:
determining a verification metric for the electronic content item based on verification statuses of multiple candidate assertions in the electronic content item;
ranking sections of the electronic content item based on the verification statuses of the multiple candidate assertions in the electronic content item.

3. The method of claim 1, further comprising:
identifying, by the processor, multiple candidate assertions in the electronic content item;
wherein the identifying the multiple candidate assertions includes one or more of:
decomposing the electronic content item into multiple candidate assertions;
parsing structured tables, source code, log entries, or markup in the electronic content item to identify the multiple candidate assertions;
filtering the multiple candidate assertions based on a parsing confidence score or an assertion type.

4. The method of claim 1, further comprising:
performing natural-language processing including at least one of dependency parsing, named-entity recognition, or pattern-based detection to identify the candidate assertion.

5. The method of claim 1, further comprising:
identifying location metadata associated with the candidate assertion in the electronic content item.

6. The method of claim 1, wherein determining the verification strategy for the candidate assertion includes one or more of:
classifying the candidate assertion into an assertion type;
determining the verification strategy based on the assertion type;
selecting a tolerance parameter or a tolerance threshold for the verification strategy based at least in part on the assertion type or on a policy.

7. The method of claim 1, further comprising:
identifying an assertion type of the candidate assertion;
wherein the verification strategy for the candidate assertion is determined at least in part from the assertion type of the candidate assertion;
determining one or more of a tolerance parameter or a threshold for the verification strategy based on the assertion type;
wherein the assertion type includes one or more of numeric, categorical, and temporal.

8. The method of claim 1, further comprising,
determining one or more of a tolerance parameter or a threshold for the verification strategy based on a policy.

9. The method of claim 1, wherein the determining the evaluation result comprises one or more of:
determining a verification status for the candidate assertion;
computing a confidence score to indicate a likelihood that the verification status is correct;
comparing the confidence score to a tolerance threshold to assess the verification status;
wherein the tolerance threshold is determined at least in part from an assertion type of the candidate assertion.

10. The method of claim 1, further comprising, one or more of:
training or configuring a machine-learning model to predict the verification strategy based on the one or more properties of the candidate assertion;
specifying, in the verification strategy, a sequence of analyses to be performed on the evidence data to evaluate the candidate assertion;
wherein the sequence of analyses is determined at least in part from an assertion type of the candidate assertion.

11. The method of claim 1, further comprising one or more of:
resolving an entity referenced in the candidate assertion to a canonical entity identifier and selecting the one or more evidence sources based on the canonical entity identifier;
generating a query request to the one or more evidence sources based on the verification strategy and/or the one or more properties of the candidate assertion.

12. The method of claim 1, further comprising one or more of:
ranking the one or more evidence sources based at least in part on one or more of source reliability, recency, or domain coverage and selecting the one or more evidence sources based at least in part on the ranking;
issuing query requests in parallel to the one or more evidence sources and aggregating the evidence data received from the one or more evidence sources;
selecting a fallback evidence source of the one or more evidence sources when a primary evidence source fails to return the evidence data that satisfy a completeness criterion.

13. The method of claim 1, further comprising:
normalizing the evidence data retrieved from the one or more evidence sources to a canonical representation;
wherein the normalizing the evidence data includes one or more of:
converting numeric values expressed in different units or currencies into a common unit or currency;
aligning financial metrics from different financial reporting periods into a common comparison period;
mapping different textual category labels into a shared taxonomy.

14. The method of claim 1, wherein,
the evaluating the candidate assertion further comprises:
resolving conflicting evidence by assigning respective weights to evidence data from different evidence sources;
combining the evidence data based at least in part on the respective weights.

15. The method of claim 1, further comprising:
generating, for the candidate assertion, a candidate assertion signature based at least in part on one or more properties of the candidate assertion;
storing in a cache the evidence data retrieved from the one or more evidence sources in association with the candidate assertion signature;
retrieving the evidence data from the cache when evaluating another candidate assertion having another candidate assertion signature that matches the candidate assertion signature.

16. The method of claim 1, further comprising, one or more of:
evaluating another candidate assertion using the evaluation result of the candidate assertion that is logically related to the other candidate assertion;
computing intermediate evaluation results based on respective subsets of the evidence data;
determining a document-level evaluation result for the electronic content item based at least in part on evaluation results for multiple candidate assertions in the electronic content item.

17. The method of claim 1, further comprising:
for the candidate assertion, generating an evaluation record that includes the evaluation result or an identifier of the evidence data used to determine the evaluation result;
generating an output including one or more of, the electronic content item and display data corresponding to the evaluation record.

18. The method of claim 1, further comprising, one or more of:
generating a modified version of the electronic content item if the evaluation result for the candidate assertion indicates contradiction or uncertainty; wherein text associated with the candidate assertion is annotated or rewritten to generate the modified version of the electronic content item;
presenting the evaluation result for the candidate assertion to a user;
receiving user feedback indicating a confirmation or override of the evaluation result and updating the evaluation result in response to the confirmation or the override;
storing user feedback associated with the evaluation result and using the user feedback to adjust a tolerance threshold or a tolerance parameter of the verification strategy.

19. A system to verify a candidate assertion in an electronic content item, comprising:
a processor;
memory having stored thereon instructions which, when executed by the processor, cause the processor to:
receive the electronic content item having natural-language text;
identify, in the electronic content item, the candidate assertion in the electronic content item to be fact verified;
determine a verification strategy for the candidate assertion based at least in part on one or more properties of the candidate assertion;
select one or more evidence sources based at least in part on the verification strategy;
retrieve evidence data from the one or more evidence sources; and
evaluate the candidate assertion based at least in part on the evidence data and the verification strategy to determine an evaluation result for the candidate assertion.

20. The system of claim 19, wherein the instructions, when executed by the processor, further cause the processor to, perform one or more of:
normalize the evidence data retrieved from the one or more evidence sources to a canonical representation prior to determining the evaluation result,
resolve conflicting evidence by assigning respective weights to evidence data from different evidence sources and combine the evidence data based at least in part on the respective weights.

21. A non-transitory computer-readable medium having stored thereon, instructions, which when executed by a processor, cause the processor to perform a method to verify a candidate assertion in an electronic content item, the method, comprising:
receiving an electronic content item having natural-language text;
identifying, in the electronic content item, the candidate assertion in the electronic content item to be fact verified;
determining a verification strategy for the candidate assertion based at least in part on one or more properties of the candidate assertion;
selecting one or more evidence sources based at least in part on the verification strategy;
retrieving evidence data from the one or more evidence sources;
normalizing the evidence data to a canonical representation evaluating the candidate assertion based at least in part on the normalized evidence data and the verification strategy to determine an evaluation result for the candidate assertion;
wherein, the evaluating includes:
determining a verification status for the candidate assertion;
computing a confidence score to indicate a likelihood that the verification status is correct;
comparing the confidence score to one or more tolerance thresholds to assess the verification status;
generating, for the candidate assertion, a candidate assertion signature based at least in part on the one or more properties of the candidate assertion;
storing in a knowledge base, the evidence data retrieved from the one or more evidence sources in association with the candidate assertion signature;
retrieving the evidence data from the knowledge base when evaluating another candidate assertion having another candidate assertion signature that matches the candidate assertion signature.
